(19) United States
(12) Patent Application Publication
(10) Pub. No.: US 2024/0340143 A1
(43) Pub. Date: Oct. 10, 2024

(54) RADAR REFERENCE SIGNAL DESIGNS FOR INTERFERENCE MANAGEMENT IN CELLULAR BASED IN RF SENSING

(71) Applicant: QUALCOMM Incorporated, San Diego, CA (US)

(72) Inventors: Weimin DUAN, San Diego, CA (US); Alexandros MANOLAKOS, Athens (GR); Tingfang JI, San Diego, CA (US); Renqiu WANG, San Diego, CA (US)

(21) Appl. No.: 18/698,661

(22) PCT Filed: Oct. 18, 2022
(86) PCT No.: PCT/US2022/047046

§ 371 Date: Apr. 4, 2024

(30) Foreign Application Priority Data
Dec. 8, 2021 (GR) 20210100855

(51) Int. Cl. H04L 5/00; H04L 1/1607

(52) U.S. Cl. CPC H04L 5/0051; H04L 1/1614; H04L 5/0012; H04L 5/0092

(57) ABSTRACT

Aspects presented herein may enhance the efficiency and performance of RF sensing schemes/mechanisms based at least in part on time and frequency domain muting. In one aspect, a base station transmits, to a plurality of TRPs, a TRP configuration to configure the plurality of TRPs to transmit one or more RRSs over multiple transmission occasions based on a frequency band. The base station transmits, to the plurality of TRPs, an indication to mute at least one of a first sub-band or a second sub-band of the frequency band for transmitting the one or more RRSs in each of the multiple transmission occasions.

### CROSS-REFERENCE TO RELATED APPLICATION

This application claims the benefit of Greek patent application Ser. No. 20210100855, entitled “RADAR REFERENCE SIGNAL DESIGNS FOR INTERFERENCE MANAGEMENT IN CELLULAR BASED RF SENSING” and filed on Dec. 8, 2021, which is expressly incorporated by reference herein in its entirety.

### TECHNICAL FIELD

The present disclosure relates generally to communication systems, and more particularly, to wireless communications involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type e communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies. Some communication systems may also support a number of cellular network-based positioning technologies, where the geographic location of a wireless device may be determined based on measuring radio signals exchanged between the wireless device and other wireless devices. For example, a distance between a wireless device and a transmission reception point (TRP) may be estimated based on the time it takes for a reference signal (e.g., a positioning reference signal (PRS)) transmitted from the TRP to reach the wireless device. Other examples of cellular network-based positioning technologies may include downlink-based, uplink-based, and/or downlink-and-uplink-based positioning methods.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a plurality of transmission reception points (TRPs), a TRP configuration to configure the plurality of TRPs to transmit one or more radar reference signals (RRSs) over multiple transmission occasions based on a frequency band. The apparatus transmits, to the plurality of TRPs, an indication to mute at least one of a first sub-band or a second sub-band of the frequency band for transmitting the one or more RRSs in each of the multiple transmission occasions.

In an aspect of the disclosure, a method, a computer-readable medium, and an apparatus are provided. The apparatus transmits, to a plurality of TRPs, a TRP configuration to configure the plurality of TRPs to transmit one or more RRSs over multiple transmission occasions based on a frequency band. The apparatus transmits, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5A is a diagram illustrating an example of downlink-positioning reference signal (DL-PRS) transmitted from multiple transmission-reception points (TRPs) in accordance with various aspects of the present disclosure.

FIG. 5B is a diagram illustrating an example of uplink-sounding reference signal (UL-SRS) transmitted from a UE in accordance with various aspects of the present disclosure.

FIG. 6 is a diagram illustrating an example of estimating a position of a UE based on multi-round trip time (RTT) measurements from multiple TRPs in accordance with various aspects of the present disclosure.

FIG. 7 is a communication flow illustrating an example multi-RTT positioning procedure in accordance with various aspects of the present disclosure.

FIG. 8 is a diagram illustrating an example of radar signals (e.g., reference radar signals (RRSs)) generated from a wireless device in accordance with various aspects of the present disclosure.

FIG. 9A is a diagram illustrating an example PRS repetition in accordance with various aspects of the present disclosure.

FIG. 9B is a diagram illustrating another example PRS repetition in accordance with various aspects of the present disclosure.

FIG. 10 is a diagram illustrating an example of PRS muting based on inter-instance muting in accordance with various aspect of the present disclosure.

FIG. 11 is a diagram illustrating an example of PRS muting based on intra-instance muting in accordance with various aspect of the present disclosure.

FIG. 12 is a diagram illustrating an example of sub-band RRS muting in accordance with various aspects of the present disclosure.

FIG. 13 is a diagram illustrating an example bitmap for muting in accordance with various aspects of the present disclosure.

FIG. 14 is a diagram illustrating an example of sub-band RRS muting with one or more common RRS resources in accordance with various aspects of the present disclosure.

FIG. 15 is a diagram illustrating another example of sub-band RRS muting with one or more common RRS resources in accordance with various aspects of the present disclosure.

FIG. 16 is a diagram illustrating an example of a non-uniform time domain RRS muting in accordance with various aspects of the present disclosure.

FIG. 17 is a diagram illustrating an example of an RRS hopping in accordance with various aspects of the present disclosure.

FIG. 18 is a flowchart of a method of wireless communication in accordance with aspects presented herein.

FIG. 19 is a flowchart of a method of wireless communication in accordance with aspects presented herein.

FIG. 20 is a diagram illustrating an example of a hardware implementation for an example apparatus in accordance with aspects presented herein.

FIG. 21 is a flowchart of a method of wireless communication in accordance with aspects presented herein.

FIG. 22 is a flowchart of a method of wireless communication in accordance with aspects presented herein.

FIG. 23 is a diagram illustrating an example of a hardware implementation for an example apparatus in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

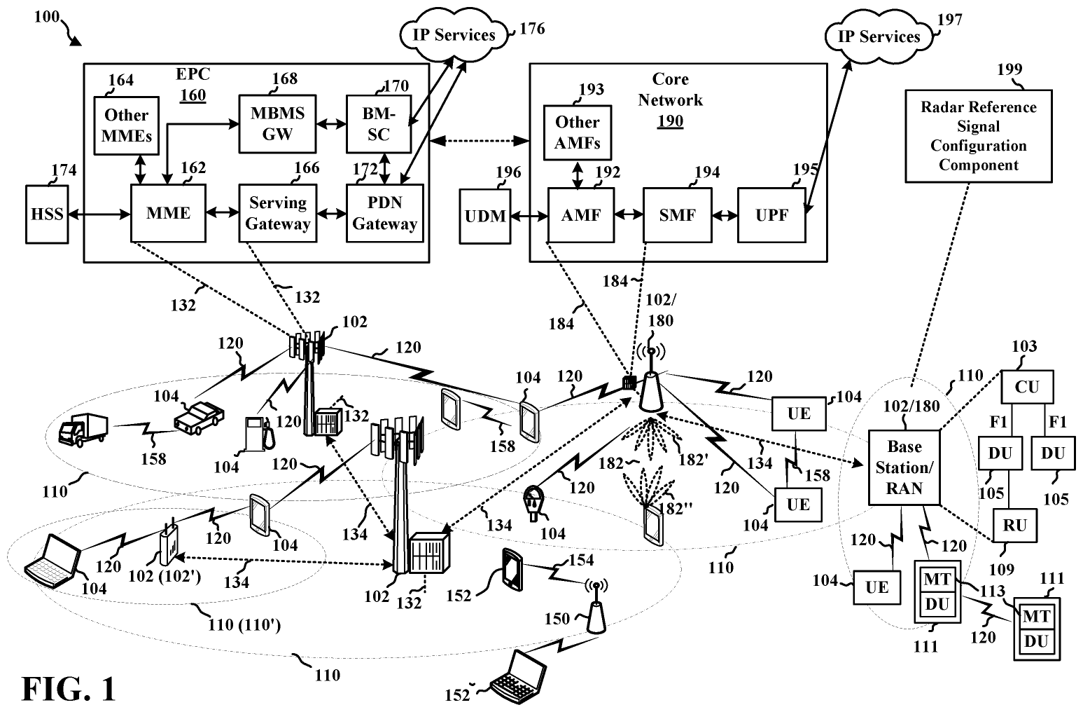

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Aspects presented herein may enhance the efficiency and performance of RF sensing schemes/mechanisms based at least in part on time and frequency domain muting and/or based at least in part on frequency hopping, where one or more wireless devices (e.g., TRPs, RF sensing nodes, UEs, etc.) may be configured to mute at least a portion of their respective RRS transmissions and/or to transmit their respective RRS transmissions based on frequency hopping to reduce interference with other communication/radar signals and/or for achieving additional power saving. Aspects presented herein may provide improved RRS transmission schemes/mechanisms that may have a shorter latency and may enable a wireless to transmit RRS contiguous in time.

In certain aspects, a base station 102/180 may include a radar reference signal configuration component 199 configured to mute at least a portion of RRS transmissions from multiple TRPs to enhance the efficiency and performance of RF sensing schemes/mechanisms or to configure multiple TRPs to transmit RRSs based on frequency hopping. In one configuration, the radar reference signal configuration component 199 may be configured to transmit, to a plurality of TRPs, a TRP configuration to configure the plurality of TRPs to transmit one or more RRSs over multiple transmission occasions based on a frequency band. In such configuration, the radar reference signal configuration component 199 may transmit, to the plurality of TRPs, an indication to mute at least one of a first sub-band or a second sub-band of the frequency band for transmitting the one or more RRSs in each of the multiple transmission occasions.

In another configuration, the radar reference signal configuration component 199 may be configured to transmit, to a plurality of TRPs, a TRP configuration to configure the plurality of TRPs to transmit one or more RRSs over multiple transmission occasions based on a frequency band. In such configuration, the radar reference signal configuration component 199 may transmit, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station 102 or 180 may be referred as a RAN and may include aggregated or disaggregated components. As an example of a disaggregated RAN, a base station may include a central unit (CU) 103, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 103, the DU 105, and the RU 109. A RAN may be disaggregated with a split between the CU 103 and an aggregated DU/RU. The CU 103 and the one or more DUs 105 may be connected via an F1 interface. A DU 105 and an RU 109 may be connected via a fronthaul interface. A connection between the CU 103 and a DU 105 may be referred to as a midhaul, and a connection between a DU 105 and an RU 109 may be referred to as a fronthaul. The connection between the CU 103 and the core network may be referred to as the backhaul. The RAN may be based on a functional split between various components of the RAN, e.g., between the CU 103, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 103 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 103 and a DU 105. IAB nodes 111 may include a DU 105 and a mobile termination (MT) 113. The DU 105 of an IAB node 111 may operate as a parent node, and the MT 113 may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

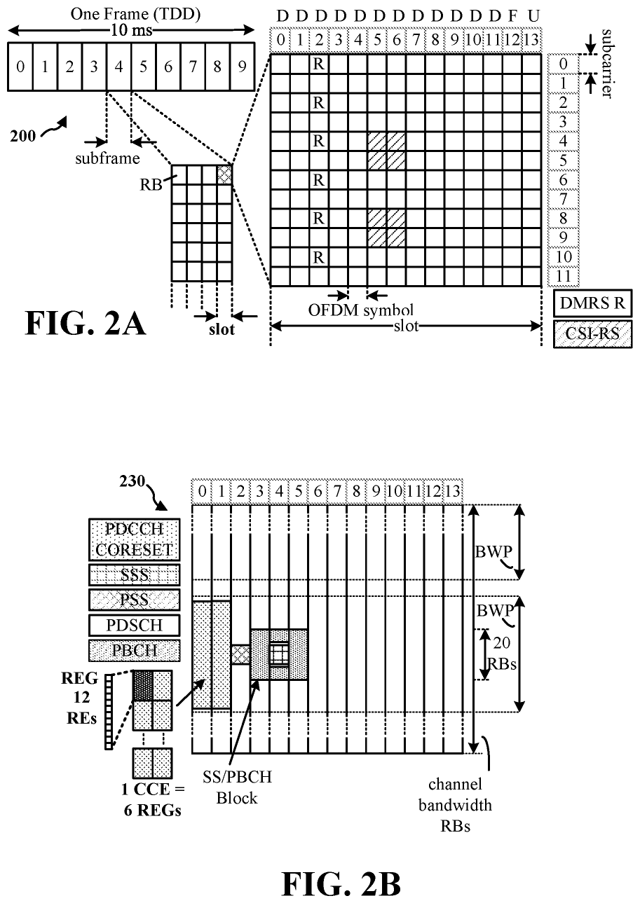

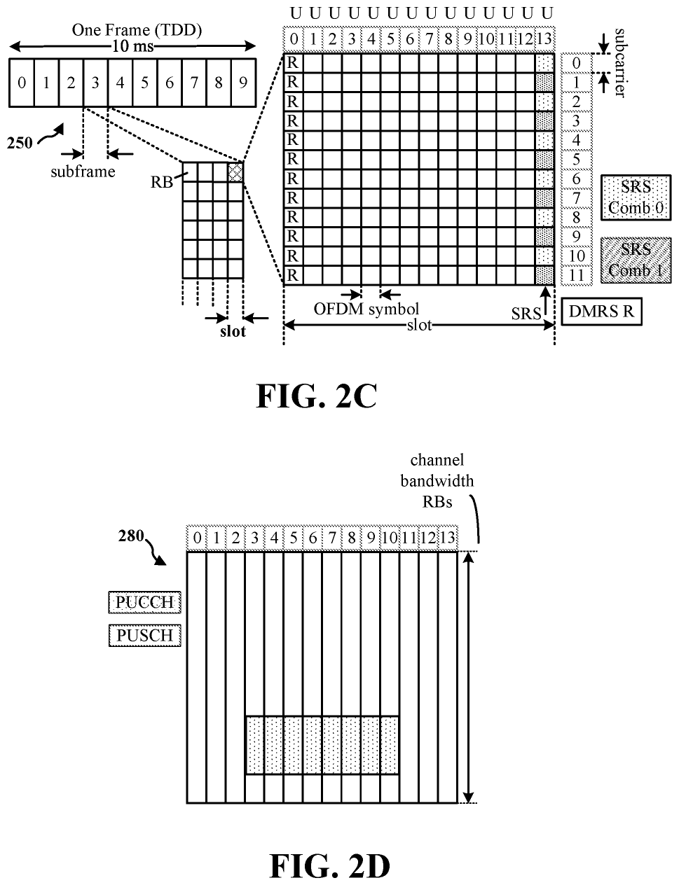

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology u=0 has a subcarrier spacing of 15 kHz and the numerology u=4 has a subcarrier spacing of 240 kHz. The symbol length/duration is inversely related to the subcarrier spacing. FIGS. 2A-2D provide an example of normal CP with 14 symbols per slot and numerology u=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

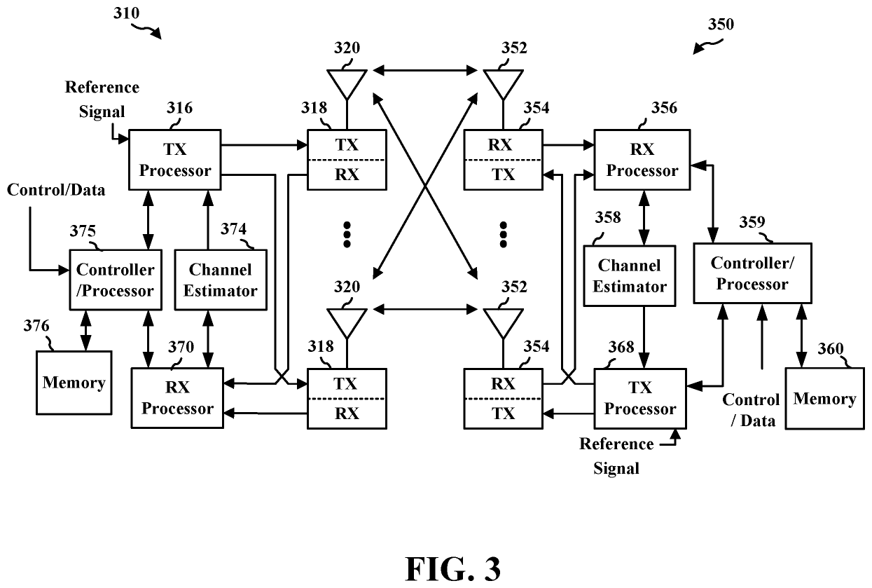

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 316, the RX processor 370, and the controller/processor 375 may be configured to perform aspects in connection with the radar reference signal configuration component 199 of FIG. 1.

A network may support a number of cellular network-based positioning technologies, such as downlink-based, uplink-based, and/or downlink-and-uplink-based positioning methods. Downlink-based positioning methods may include an observed time difference of arrival (OTDOA) (e.g., in LTE), a downlink time difference of arrival (DL-TDOA) (e.g., in NR), and/or a downlink angle-of-departure (DL-AoD) (e.g., in NR). In an OTDOA or DL-TDOA positioning procedure, a UE may measure the differences between each time of arrival (ToA) of reference signals (e.g., positioning reference signals (PRSs)) received from pairs of base stations, referred to as reference signal time difference (RSTD) measurements or time difference of arrival (TDOA) measurements, and report them to a positioning entity (e.g., a location management function (LMF)). For example, the UE may receive identifiers (IDs) of a reference base station (which may also be referred to as a reference cell or a reference gNB) and at least one non-reference base station in assistance data (AD). The UE may then measure the RSTD between the reference base station and each of the non-reference base stations. Based on the known locations of the involved base stations and the RSTD measurements, the positioning entity may estimate a location of the UE. In other words, a position of the UE may be estimated based on measuring reference signals transmitted between the UE and one or more base stations and/or transmission-reception points (TRPs) of the one or more base stations. As such, the PRSs may enable UEs to detect and measure neighbor TRPs, and to perform positioning based on the measurement. For purposes of the present disclosure, the suffixes “-based” and “-assisted” may refer respectively to the node that is responsible for making the positioning calculation (and which may also provide measurements) and a node that provides measurements (but which may not make the positioning calculation). For example, an operation in which measurements are provided by a UE to a base station/positioning entity to be used in the computation of a position estimate may be described as “UE-assisted,” “UE-assisted positioning,” and/or “UE-assisted position calculation” while an operation in which a UE computes its own position may be described as “UE-based,” “UE-based positioning,” and/or “UE-based position calculation.”

In some examples, the term “TRP” may refer to one or more antennas of a base station whereas the term “base station” may refer to a complete unit (e.g., the base station 102/180) that includes aggregated or disaggregated components, such as described in connection with FIG. 1. For example, as an example of a disaggregated RAN, a base station may include CU, one or more DUs, one or more RUs, and/or one or more TRPs. One or more disaggregated components may be located at different locations. For example, different TRPs may be located at different geographic locations. In another example, a TRP may refer to a set of geographically co-located antennas (e.g., antenna array (with one or more antenna elements)) supporting transmission point (TP) and/or reception point (RP) functionality. Thus, a base station may transmit signal to and/or receive signal from other wireless device (e.g., a UE, another base station, etc.) via one or more TRPs. For purposes of the present disclosure, in some examples, the term “TRP” may be used interchangeably with the term “base station.”

For DL-AoD positioning, the positioning entity may use a beam report from the UE of received signal strength measurements of multiple downlink transmit beams to determine the angle(s) between the UE and the transmitting base station(s). The positioning entity may then estimate the location of the UE based on the determined angle(s) and the known location(s) of the transmitting base station(s).

Uplink-based positioning methods may include UL-TDOA and UL-AoA. UL-TDOA is similar to DL-TDOA, but is based on uplink reference signals (e.g., sounding reference signals (SRSs)) transmitted by the UE. For UL-AoA positioning, one or more base stations may measure the received signal strength of one or more uplink reference signals (e.g., SRSs) received from a UE on one or more uplink receive beams. The positioning entity may use the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods may include enhanced cell-ID (E-CID) positioning and multi-round-trip-time (RTT) positioning (also referred to as “multi-cell RTT”). In an RTT procedure, an initiator (a base station or a UE) transmits an RTT measurement signal (e.g., a PRS or SRS) to a responder (a UE or a base station), which transmits an RTT response signal (e.g., an SRS or a PRS) back to the initiator. The RTT response signal may include the difference between the ToA of the RTT measurement signal and the transmission time of the RTT response signal, referred to as the reception-to-transmission (Rx−Tx) time difference. The initiator may calculate the difference between the transmission time of the RTT measurement signal and the ToA of the RTT response signal, referred to as the transmission-to-reception (Tx-Rx) time difference. The propagation time (also referred to as the “time of flight”) between the initiator and the responder may be calculated from the Tx-Rx and Rx−Tx time differences. Based on the propagation time and the known speed of light, the distance between the initiator and the responder may be determined. For multi-RTT positioning, a UE may perform an RTT procedure with multiple base stations to enable its location to be determined (e.g., using multilateration) based on the known locations of the base stations. RTT and multi-RTT methods may be combined with other positioning techniques, such as UL-AoA and DL-AoD, to improve location accuracy.

The E-CID positioning method may be based on radio resource management (RRM) measurements. In E-CID, the UE may report the serving cell ID and the timing advance (TA), as well as the identifiers, estimated timing, and signal strength of detected neighbor base stations. The location of the UE is then estimated based on this information and the known locations of the base station(s).

To assist positioning operations, a location server (e.g., a location server, an LMF, or an SLP) may provide assistance data (AD) to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations (e.g., in periodically broadcasted overhead messages, etc.). In some cases, the UE may be able to detect neighbor network nodes without the use of assistance data.

In the case of an OTDOA or DL-TDOA positioning procedure, the assistance data may further include an expected RSTD value and an associated uncertainty (e.g., a search space window) around the expected RSTD. In some cases, the value range of the expected RSTD may be plus-minus (+/−) 500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs. In this context, “RSTD” may refer to one or more measurements indicative of a difference in time of arrival between a PRS transmitted by a base station, referred to herein as a “neighbor base station” or a “measuring base station,” and a PRS transmitted by a reference base station. A reference base station may be selected by a location server and/or by a UE to provide good or sufficient signal strength observed at a UE, such that a PRS may be more accurately and/or more quickly acquired and/or measured, such as without any special assistance from a serving base station.

A location estimate may also be referred to as a position estimate, location, position, position fix, fix, or the like. A location estimate may be geodetic and include coordinates (e.g., latitude, longitude, and possibly altitude) or may be civic and include a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence). For purposes of the present disclosure, reference signals may include PRS, tracking reference signals (TRS), phase tracking reference signals (PTRS), cell-specific reference signals (CRS), CSI-RS, demodulation reference signals (DMRS), PSS, SSS, SSBs, SRS, etc., depending on whether the illustrated frame structure is used for uplink or downlink communication. In some examples, a collection of resource elements (REs) that are used for transmission of PRS may be referred to as a “PRS resource.” The collection of resource elements may span multiple PRBs in the frequency domain and one or more consecutive symbol(s) within a slot in the time domain. In a given OFDM symbol in the time domain, a PRS resource may occupy consecutive PRBs in the frequency domain. In other examples, a “PRS resource set” may refer to a set of PRS resources used for the transmission of PRS signals, where each PRS resource may have a PRS resource ID. In addition, the PRS resources in a PRS resource set may be associated with a same TRP. A PRS resource set may be identified by a PRS resource set ID and may be associated with a particular TRP (e.g., identified by a TRP ID). In addition, the PRS resources in a PRS resource set may have a same periodicity, a common muting pattern configuration, and/or a same repetition factor across slots. The periodicity may be a time from a first repetition of a first PRS resource of a first PRS instance to the same first repetition of the same first PRS resource of the next PRS instance. For example, the periodicity may have a length selected from 2\hat{ }μ*{4, 5, 8, 10, 16, 20, 32, 40, 64, 80, 160, 320, 640, 1280, 2560, 5120, 10240} slots, where μ=0, 1, 2, 3. The repetition factor may have a length selected from {1, 2, 4, 6, 8, 16, 32} slots. A PRS resource ID in a PRS resource set may be associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” In some examples, a “PRS instance” or “PRS occasion” may be one instance of a periodically repeated time window (such as a group of one or more consecutive slots) where PRS are expected to be transmitted. A PRS occasion also may be referred to as a “PRS positioning occasion,” a “PRS positioning instance,” a “positioning occasion,” “a positioning instance,” a “positioning repetition,” or simply an “occasion,” an “instance,” and/or a “repetition,” etc.

A positioning frequency layer (PFL) (which may also be referred to as a “frequency layer”) may be a collection of one or more PRS resource sets across one or more TRPs that have the same values for certain parameters. Specifically, the collection of PRS resource sets may have a same subcarrier spacing and cyclic prefix (CP) type (e.g., meaning all numerologies supported for PDSCHs are also supported for PRS), the same Point A, the same value of the downlink PRS bandwidth, the same start PRB (and center frequency), and/or the same comb-size, etc. The Point A parameter may take the value of a parameter ARFCN-ValueNR (where “ARFCN” stands for “absolute radio-frequency channel number”) and may be an identifier/code that specifies a pair of physical radio channel used for transmission and reception. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer.

The concept of a frequency layer may be similar to a component carrier (CC) and a BWP, where CCs and BWPs may be used by one base station (or a macro cell base station and a small cell base station) to transmit data channels, while frequency layers may be used by multiple (e.g., three or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

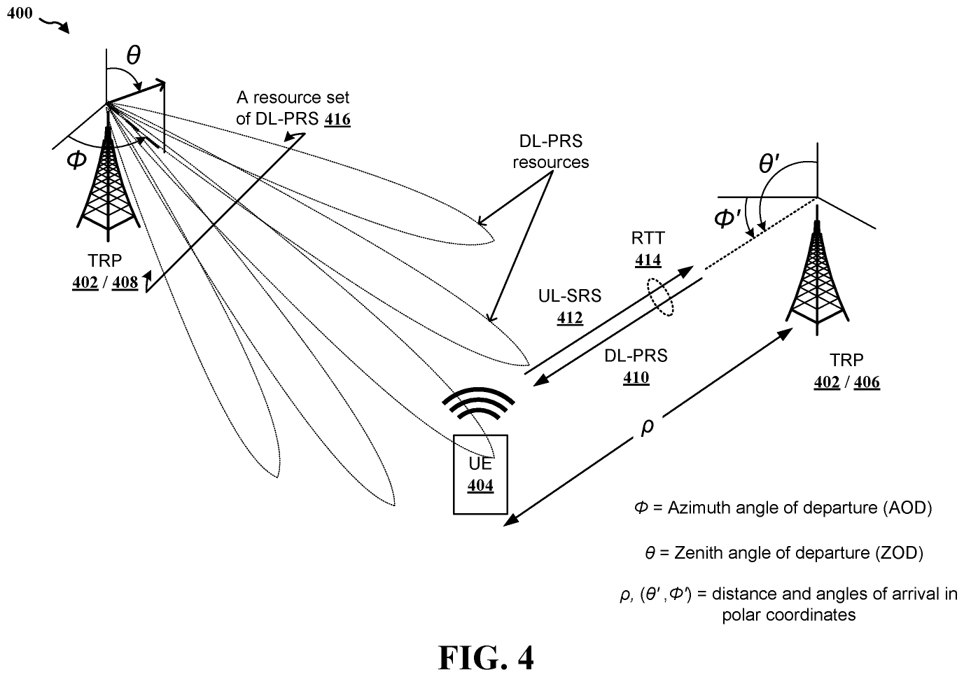

FIG. 4 is a diagram 400 illustrating an example of a UE positioning based on reference signal measurements in accordance with various aspects of the present disclosure. In one example, a location of UE 404 may be estimated based on multi-cell round trip time (multi-RTT) measurements, where multiple TRPs 402 may perform round trip time (RTT) measurements for signals transmitted to and received from the UE 404 to determine the approximate distance of UE 404 with respect to each of the multiple TRPs 402. Similarly, the UE 404 may perform RTT measurements for signals transmitted to and received from the TRPs 402 to determine the approximate distance of each TRP with respect to the UE 404. Then, based at least in part on the approximate distances of UE 404 with respect to the multiple TRPs 402, a location management function (LMF) that is associated with the TRPs 402 and/or the UE 404 may estimate the position of UE 404. For example, a TRP 406 may transmit at least one downlink positioning reference signal (DL-PRS) 410 to the UE 404, and may receive at least one uplink sounding reference signal (UL-SRS) 412 transmitted from the UE 404. Based at least in part on measuring an RTT 414 between the DL-PRS 410 transmitted and the UL-SRS 412 received, a serving base station associated with the TRP 406 or an LMF associated with the TRP 406 may identify the position of UE 404 (e.g., distance) with respect to the TRP 406. Similarly, the UE 404 may transmit UL-SRS 412 to the TRP 406, and may receive DL-PRS 410 transmitted from the TRP 406. Based at least in part on measuring the RTT 414 between the UL-SRS 412 transmitted and the DL-PRS 410 received, the UE 404 or an LMF associated with the UE 404 may identify the position of TRP 406 with respect to the UE 404. The multi-RTT measurement mechanism may be initiated by the LMF that is associated with the TRP 406/408 and/or the UE 404. A TRP may configure UL-SRS resources to a UE via radio resource control (RRC) signaling. In some examples, the UE and the TRP may report the multi-RTT measurements to the LMF, and the LMF may estimate the position of the UE based on the reported multi-RTT measurements.

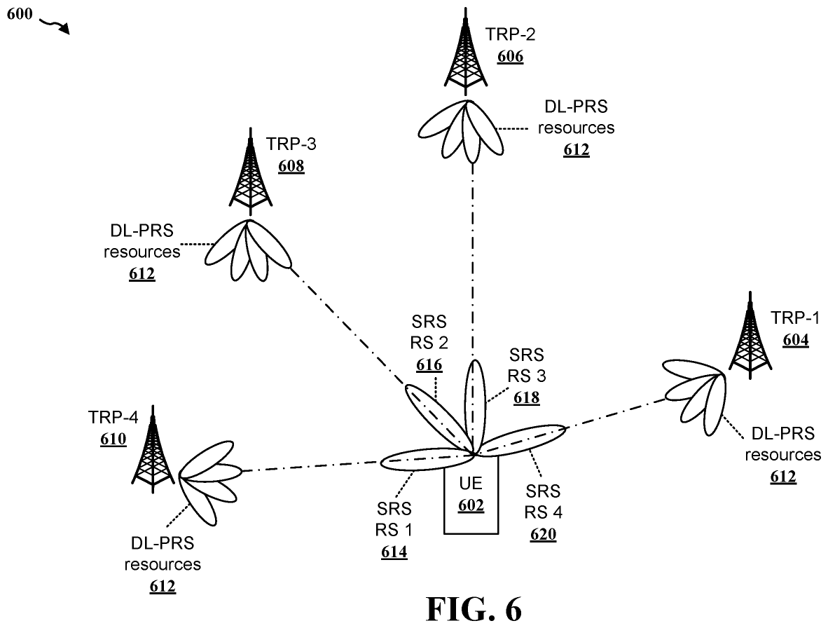

In other examples, a position of a UE may be estimated based on multiple antenna beam measurements, where a downlink angle of departure (DL-AoD) and/or uplink angle of arrival (UL-AoA) of transmissions between a UE and one or more TRPs may be used to estimate the position of the UE and/or the distance of the UE with respect to each TRP. For example, referring back to FIG. 6, with regard to the DL-AoD, the UE 404 may perform reference signal received power (RSRP) measurements for a set of DL-PRS 416 transmitted from multiple transmitting beams (e.g., DL-PRS beams) of a TRP 408, and the UE 404 may provide the DL-PRS beam measurements to a serving base station (or to the LMF associated with the base station). Based on the DL-PRS beam measurements, the serving TRP or the LMF may derive the azimuth angle (e.g., Φ) of departure and the zenith angle (e.g., θ) of departure for DL-PRS beams of the TRP 408. Then, the serving TRP or the LMF may estimate the position of UE 404 with respect to the TRP 408 based on the azimuth angle of departure and the zenith angle of departure of the DL-PRS beams. Similarly, for the UL-AoA, a position of a UE may be estimated based on UL-SRS beam measurements measured at different TRPs, such as at the TRPs 402. Based on the UL-SRS beam measurements, a serving base station or an LMF associated with the serving base station may derive the azimuth angle of arrival and the zenith angle of arrival for UL-SRS beams from the UE, and the serving base station or the LMF may estimate the position of the UE and/or the UE distance with respect to each of the TRPs based on the azimuth angle of arrival and the zenith angle of arrival of the UL-SRS beams.

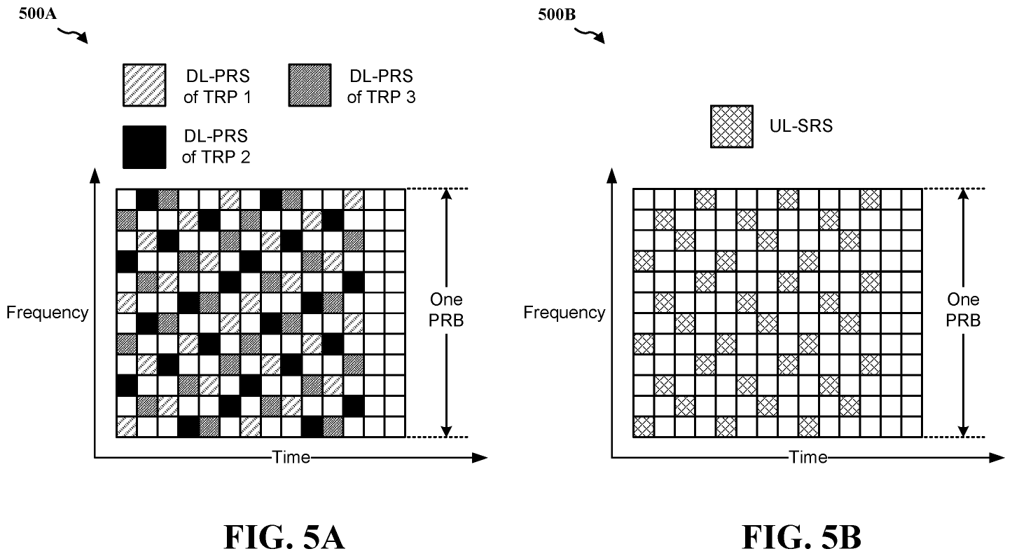

FIG. 5A is a diagram 500A illustrating an example of DL-PRS transmitted from multiple TRPs in accordance with various aspects of the present disclosure. In one example, a serving base station may configure DL-PRS to be transmitted from one or more TRPs within a slot or across multiple slots. If the DL-PRS is configured to be transmitted within a slot, the serving base station may configure the starting resource element in time and frequency from each of the one or more TRPs. If the DL-PRS is configured to be transmitted across multiple slots, the serving base station may configure gaps between DL-PRS slots, periodicity of the DL-PRS, and/or density of the DL-PRS within a period. The serving base station may also configure the DL-PRS to start at any physical resource block (PRB) in the system bandwidth. In one example, the system bandwidth may range from 24 to 276 PRBs in steps of 4 PRBs (e.g., 24, 28, 32, 36, etc.). The serving base station may transmit the DL-PRS in PRS beams, where a PRS beam may be referred to as a “PRS resource” and a full set of PRS beams transmitted from a TRP on a same frequency may be referred to as a “PRS resource set” or a “resource set of PRS,” such as described in connection with FIG. 4. As shown by FIG. 5A, the DL-PRS transmitted from different TRPs and/or from different PRS beams may be multiplexed across symbols or slots.

In some examples, each symbol of the DL-PRS may be configured with a comb-structure in frequency, where the DL-PRS from a TRP of a base station may occupy every N^{th} subcarrier. The comb value N may be configured to be 2, 4, 6, or 12. The length of the PRS within one slot may be a multiple of N symbols and the position of the first symbol within a slot may be flexible as long as the slot consists of at least N PRS symbols. The diagram 500A shows an example of a comb-6 DL-PRS configuration, where the pattern for the DL-PRS from different TRPs may be repeated after six (6) symbols.

FIG. 5B is a diagram 500B illustrating an example of UL-SRS transmitted from a UE in accordance with various aspects of the present disclosure. In one example, the UL-SRS from a UE may be configured with a comb-4 pattern, where the pattern for UL-SRS may be repeated after four (4) symbols. Similarly, the UL-SRS may be configured in an SRS resource of an SRS resource set, where each SRS resource may correspond to an SRS beam, and the SRS resource sets may correspond to a collection of SRS resources (e.g., beams) configured for a TRP. In some examples, the SRS resources may span 1, 2, 4, 8, or 12 consecutive OFDM symbols. In other examples, the comb size for the UL-SRS may be configured to be 2, 4, or 8.

FIG. 6 is a diagram 600 illustrating an example of estimating a position of a UE based on multi-RTT measurements from multiple TRPs in accordance with various aspects of the present disclosure. A UE 602 may be configured by a serving base station to decode DL-PRS resources 612 that correspond to and are transmitted from a first TRP 604 (TRP-1), a second TRP 606 (TRP-2), a third TRP 608 (TRP-3), and a fourth TRP 610 (TRP-4). The UE 602 may also be configured to transmit UL-SRSs on a set of UL-SRS resources, which may include a first SRS resource 614, a second SRS resource 616, a third SRS resource 618, and a fourth SRS resource 620, such that the serving cell(s), e.g., the first TRP 604, the second TRP 606, the third TRP 608, and the fourth TRP 610, and as well as other neighbor cell(s), may be able to measure the set of the UL-SRS resources transmitted from the UE 602. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

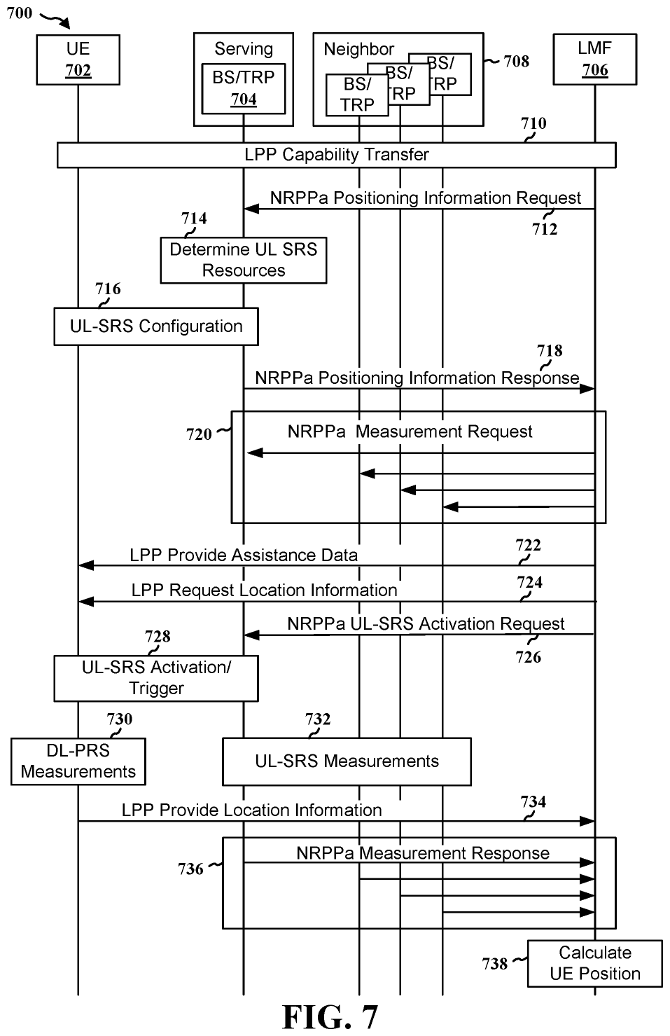

FIG. 7 is a communication flow 700 illustrating an example multi-RTT positioning procedure in accordance with various aspects of the present disclosure. The numberings associated with the communication flow 700 do not specify a particular temporal order and are merely used as references for the communication flow 700. In addition, a DL-only and/or an UL-only positioning may use a subset or subsets of this multi-RTT positioning procedure.

At 710, an LMF 706 may request one or more positioning capabilities from a UE 702 (e.g., from a target device). In some examples, the request for the one or more positioning capabilities from the UE 702 may be associated with an LTE Positioning Protocol (LPP). For example, the LMF 706 may request the positioning capabilities of the UE 702 using an LPP capability transfer procedure.

At 712, the LMF 706 may request UL SRS configuration information for the UE 702. The LMF 706 may also provide assistance data specified by a serving base station 704 (e.g., pathloss reference, spatial relation, and/or SSB configuration(s), etc.). For example, the LMF 706 may send an NR Positioning Protocol A (NRPPa) positioning information request message to the serving base station 704 to request UL information for the UE 702.

At 714, the serving base station 704 may determine resources available for UL SRS, and at 716, the serving base station 704 may configure the UE 702 with one or more UL SRS resource sets based on the available resources.

At 718, the serving base station 704 may provide UL SRS configuration information to the LMF 706, such as via an NRPPa positioning information response message.

At 720, the LMF 706 may select one or more candidate neighbor BSs/TRPs 708, and the LMF 706 may provide an UL SRS configuration to the one or more candidate neighbor BSs/TRPs 708 and/or the serving base station 704, such as via an NRPPa measurement request message. The message may include information for enabling the one or more candidate neighbor BSs/TRPs 708 and/or the serving base station to perform the UL measurements.

At 722, the LMF 706 may send an LPP provide assistance data message to the UE 702. The message may include specified assistance data for the UE 702 to perform the DL measurements.

At 724, the LMF 706 may send an LPP request location information message to the UE 702 to request multi-RTT measurements.

At 726, for semi-persistent or aperiodic UL SRS, the LMF 706 may request the serving base station 704 to activate/trigger the UL SRS in the UE 702. For example, the LMF 706 may request activation of UE SRS transmission by sending an NRPPa positioning activation request message to the serving base station 704.

At 728, the serving base station 704 may activate the UE SRS transmission and send an NRPPa positioning activation response message. In response, the UE 702 may begin the UL-SRS transmission according to the time domain behavior of UL SRS resource configuration.

At 730, the UE 702 may perform the DL measurements from the one or more candidate neighbor BSs/TRPs 708 and/or the serving base station 704 provided in the assistance data. At 732, each of the configured one or more candidate neighbor BSs/TRPs 708 and/or the serving base station 704 may perform the UL measurements.

At 734, the UE 702 may report the DL measurements to the LMF 706, such as via an LPP provide location information message.

At 736, each of the one or more candidate neighbor BSs/TRPs 708 and/or the serving base station 704 may report the UL measurements to the LMF 706, such as via an NRPPa measurement response message.

At 738, the LMF 706 may determine the RTTs from the UE 702 and BS/TRP Rx−Tx time difference measurements for each of the one or more candidate neighbor BSs/TRPs 708 and/or the serving base station 704 for which corresponding UL and DL measurements were provided at 734 and 736, and the LMF 706 may calculate the position of the UE 702.

In addition to network-based UE positioning technologies, a wireless device (e.g., a base station, a UE, etc.) may also be configured to include radar capabilities, which may be referred to as “radio frequency (RF) sensing” and/or “cellular-based RF sensing.” For example, a wireless device may transmit radar reference signals (RRSs) and measure the RRSs reflected from one or more objects. Based at least in part on the measurement, the wireless device may determine or estimate a distance between the wireless device and the one or more objects based. In another example, a first wireless device may also receive RRSs transmitted from one or more wireless devices, where the first wireless device may determine or estimate a distance between the first wireless device and one or more wireless devices based at least in part on the received RRS. As such, in some examples, RF sensing techniques may be used for UE positioning and/or for assisting UE positioning.

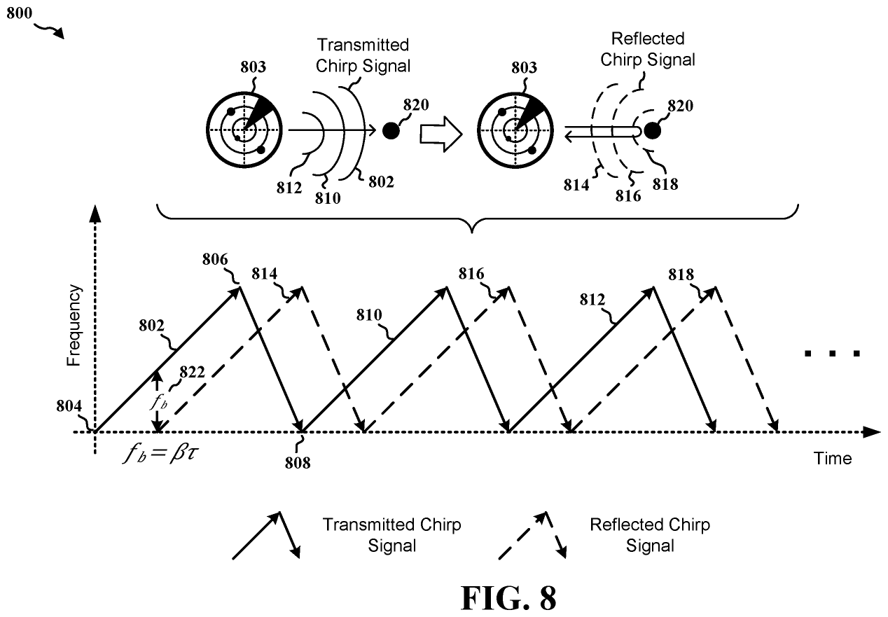

FIG. 8 is a diagram 800 illustrating an example of radar signals (e.g., RRSs) generated from a wireless device in accordance with various aspects of the present disclosure. A wireless device 803 (e.g., a base station, a TRP, a UE, a device configured to perform radar functions, etc.) may detect an object 820 (e.g., the location and/or the distance of the object with 820 with respect to the wireless device 803) by transmitting a set of RRSs. In some examples, the object 820 may be a radar receiver or have a capability to receive and process RRSs. In one example, the set of RRSs may be chirp signals, where each chirp signal may include a frequency that varies linearly (e.g., has a frequency sweeping) over a fixed period of time (e.g., over a sweep time) by a modulating signal. For example, as shown by the diagram 800, a transmitted chirp signal 802 may have a starting frequency at 804 of a sinusoid. Then, the frequency may gradually (e.g., linearly) increase on the sinusoid until it reaches an ending (or highest) frequency at 806 of the sinusoid, and then the frequency of the signal may return to 808 and another chirp signal 810 may be transmitted in the same way. In other words, each chirp signal may include an increase in the frequency (e.g., linearly) and a drop in the frequency or vice versa (e.g., includes a decrease in frequency and then an increase in frequency), such that the wireless device 803 may transmit chirp signals sweeping in frequency. In some examples, such chirp signal may also be referred to as a frequency modulated continuous wave (FMCW).

After one or more chirp signals (e.g., chirp signals 802, 810, 812, etc.) are transmitted by the wireless device 803, the transmitted chirp signals may reach the object 820 and reflect back to the wireless device 803, such as shown by the reflected chirp signals 814, 816, and 818, which may correspond to the transmitted chirp signals 802, 810, and 812, respectively. As there may be a distance between the wireless device 803 and the object 820 and/or it may take time for a transmitted chirp signal to reach the object 820 and reflect back to the wireless device 803, a delay may exist between a transmitted chirp signal and its corresponding reflected chirp signal. The delay may be proportional to a range between the wireless device 803 and the object 820 (e.g., the further the target, the larger the delay and vice versa). Thus, the wireless device 803 may be able to measure or estimate a distance between the wireless device 803 and the object 820 based on the delay.

In some examples, the wireless device 803 may also measure a difference in frequency between the transmitted chirp signal and the reflected chirp signal, which may also be proportional to the distance between the wireless device 803 and the object 820. In other words, as the frequency difference between the reflected chirp signal and the transmitted chirp signal increases with the delay, and the delay is linearly proportional to the range, the distance of the object 820 from the wireless device 803 may also be determined based on the difference in frequency. Thus, the reflected chirp signal from the object 820 may be mixed with the transmitted chirp signal and down-converted to produce a beat signal (fb) which may be linearly proportional to the range after demodulation. For example, the wireless device 803 may determine a beat signal 822 by mixing the transmitted chirp signal 802 and its corresponding reflected chirp signal 814. While examples in the diagram illustrate using an FMCW waveform for the RRSs, other types of radar waveforms may also be used by the wireless device 803 for the RRSs.

In some scenarios, to improve the performance and accuracy of a UE positioning session, PRS/DL-PRS transmitted from a base station or TRP may be configured with repetitions. For example, in a single instance of a PRS resource set, a base station may be configured to repeat transmission(s) of each PRS resource within the PRS resource set for a number of times, where the number of times may include 1, 2, 4, 6, 8, 16, and 32, etc. The base station may also indicate the number of repetitions to a UE, such as via an PRS-ResourceRepetitionFactor parameter. For example, if PRS-ResourceRepetitionFactor is equal to 2, then each PRS resource may be transmitted two times. In addition, the base station may also transmit repetitions of a PRS resource with a time offset, such that PRS repetitions may be transmitted with a time gap. Similarly, the base station may also indicate to the UE regarding the time offset, such as via an PRS-ResourceTimeGap parameter. For example, the base station may use the PRS-ResourceTimeGap parameter to indicate to a UE regarding the time offset in units of slots between two repeated instances of a PRS resource corresponding to the same PRS resource ID within a single instance of the PRS resource set, where values that may be configured for the PRS-ResourceTimeGap parameter may include 1, 2, 4, 8, 16, and 32 (e.g., if PRS-ResourceTimeGap=2, then each PRS resource is transmitted two slots apart). In some examples, the time duration spanned by one PRS resource set containing repeated PRS resources may be specified not to exceed the PRS periodicity.

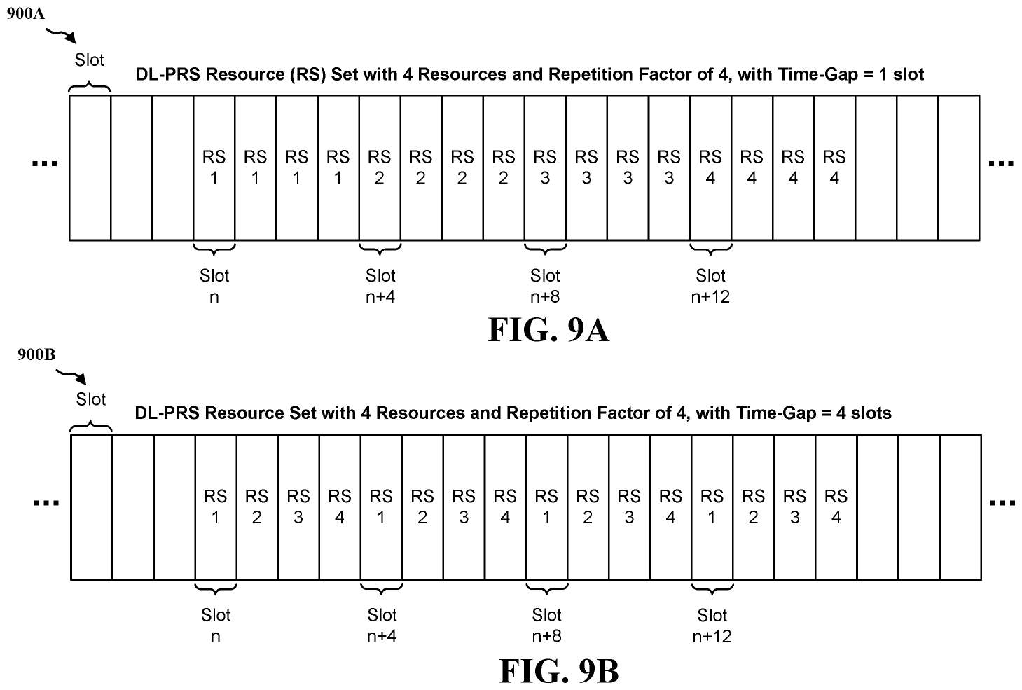

FIG. 9A is a diagram 900A illustrating an example PRS repetition in accordance with various aspects of the present disclosure. If a DL-PRS resource set with four (4) PRS resources (e.g., RS 1, RS 2, RS 3, and RS 4) is configured with a repetition factor of four (e.g., PRS-ResourceRepetitionFactor=4) and a time gap of one slot (e.g., PRS-ResourceTimeGap=1), a base station may transmit four repetitions of a first PRS resource (RS 1) in the first four slots (e.g., from slot n to slot n+3), transmit four repetitions of a second PRS resource (RS 2) in the next four slots (e.g., from slot n+4 to slot n+7), transmit four repetitions of a third PRS resource (RS 3) in the next four slots (e.g., from slot n+8 to slot n+11), and transmit four repetitions of a fourth PRS resource (RS 4) in the next four slots (e.g., from slot n+12 to slot n+15).

FIG. 9B is a diagram 900B illustrating another example PRS repetition in accordance with various aspects of the present disclosure. If a DL-PRS resource set with four (4) PRS resources (e.g., RS 1, RS 2, RS 3, and RS 4) is configured with a repetition factor of four (e.g., PRS-ResourceRepetitionFactor=4) and a time gap of four slots (e.g., PRS-ResourceTimeGap=4), a base station may transmit four repetitions of a first PRS resource (RS 1) after every four slots (e.g., at slots n, n+4, n+8, and n+12), transmit four repetitions of a second PRS resource (RS 2) after the first PRS resource (RS 1) and also after every four slots (e.g., at slots n+1, n+5, n+9, and n+13), transmit four repetitions of a third PRS resource (RS 3) after the second PRS resource (RS 2) and also after every four slots (e.g., at slots n+2, n+6, n+10, and n+14), and transmit four repetitions of a fourth PRS resource (RS 4) after the third PRS resource (RS 3) and also after every four slots (e.g., at slots n+3, n+7, n+11, and n+15).

By transmitting a PRS resource with repetition(s), the performance and accuracy of a UE positioning session may be improved. For example, if a base station/TRP is transmitting PRSs with repetitions to a UE, the UE may perform reception (Rx) beam sweeping across the PRS repetitions to determine which Rx beam(s) of the UE are more suitable for communicating with the base station/TRP. In some examples, the UE may also combine gains of different PRS repetitions for coverage extension. In other examples, how a UE performs Rx beam sweeping for PRS repetitions may be based on UE implementation and not configured by the network or the serving base station.

In some scenarios, after a TRP is scheduled to transmit on a set of PRS resources, the TRP (or the base station associated with the TRP) may determine to mute some of the PRS transmissions, such as for purposes of reducing interference and/or for power consumption, etc. If a PRS resource is being muted, the TRP may transmit a PRS based on the PRS resource with zero-power. For example, if PRSs transmitted from a serving TRP have a stronger signal strength than PRSs transmitted from a neighbor TRP (from a UE's perspective), then the serving TRP may determine to mute some of its PRS transmissions, such that PRSs transmitted from the neighbor TRP may be more easily detected by the UE.

When a base station has determined to mute one or more PRS resources, the base station may inform a UE regarding which PRS resources are being muted, such that the UE may skip monitoring/receiving PRSs associated with the muted PRS resources. For example, a base station may signal a UE with bitmap(s) to indicate which PRS resources are transmitted with zero-power (e.g., are muted), where the length of the bitmap(s) may be 2, 4, 6, 8, 16, and/or 32 bits in some examples. In other words, the PRS muting configuration of a TRP may be defined by a periodic muting sequence with a periodicity TREP, where TREP counted in number of PRS positioning occasions may be 2, 4, 8, and/or 16. The PRS muting information may be represented by a bitmap (or a bit string) of length 2, 4, 8, and/or 16 bits (e.g., corresponding to the selected TREP), and each bit in this bitmap may have the value “0” (bit zero) or “1” (bit one). If a bit in the bitmap (or the PRS muting information) is set to “0”, then the PRS may be muted in the corresponding PRS positioning occasion. The first bit of the PRS muting sequence may correspond to the first PRS positioning occasion that starts after the beginning of the assistance data reference cell SFN=0. In addition, the PRS muting may be based on inter-instance muting, or based on intra-instance muting, or based on both. For example, the inter-instance muting and the intra-instance muting may be used together if a PRS muting pattern is provided to a UE for both muting options (and a logical AND operation is applied).

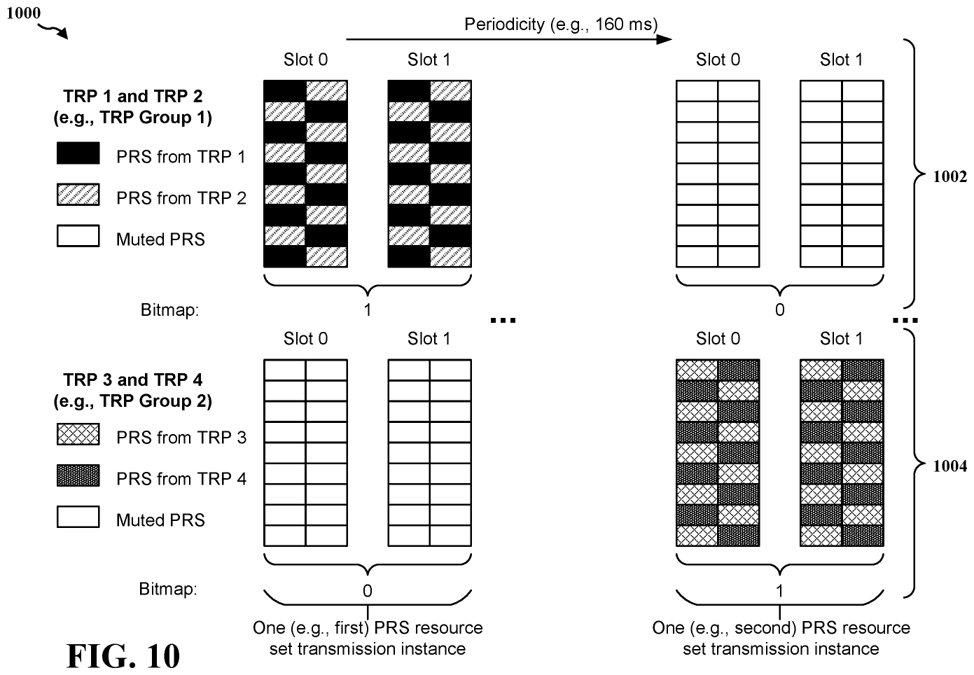

FIG. 10 is a diagram 1000 illustrating an example of PRS muting based on inter-instance muting in accordance with various aspects of the present disclosure. An LMF or a serving base station may configure a set of PRS resources with a comb-2/2-symbol configuration (e.g., as described in connection with FIG. 5A) and with a PRS repetition factor of two (e.g., PRS-ResourceRepetitionFactor=2) to be transmitted from a first TRP, a second TRP, a third TRP, and a fourth TRP to a UE.

Under the inter-instance muting, PRS muting may apply to each transmission instance of a PRS resource set, where the base station/LMF may configure different TRPs or different groups of TRPs to mute at different PRS resource set transmission instances to reduce interference between TRPs. For example, at a first PRS resource set transmission instance, the base station/LMF may configure the first TRP and the second TRP to transmit their PRSs and mute PRS transmissions from the third TRP and the fourth TRP. Then, at a second PRS resource set transmission instance, the base station/LMF may configure the third TRP and the fourth TRP to transmit their PRSs and mute PRS transmissions from the first TRP and the second TRP.

The base station may indicate the muted PRS resources to the UE via a bitmap. In one example, each bit in the bitmap may correspond to a configurable number of consecutive instances of a PRS resource set controlled by a PRS Muting-Bit Repetition Factor, with values including 1, 2, 4, and/or 8. For example, as shown at 1002, if the base station has determined to transmit a set of PRSs to a UE via the first TRP and the second TRP (or via a first group of TRPs (TRP Group 1) that includes both the first TRP and the second TRP) in a first PRS resource set transmission instance, and the base station has also determined to mute the PRS in a second PRS resource set transmission instance, the base station may transmit a bitmap of {1,0} to the UE to inform the UE that the second PRS resource set transmission instance from the first TRP and the second TRP is muted (e.g., transmitted with zero-power). As such, the UE may skip monitoring for PRSs transmitted from the first TRP and the second TRP during the second PRS resource set transmission instance. Similarly, as shown at 1004, if the base station has determined to mute a set of PRSs transmitted to the UE via the third TRP and the fourth TRP (or via a second group of TRPs (TRP Group 2) that includes both the third TRP and the fourth TRP) in a first PRS resource set transmission instance, and the base station has also determined to transmit a set of PRSs to the UE via the third TRP and the fourth TRP in a second PRS resource set transmission instance, the base station may transmit a bitmap of {0,1} to the UE to inform the UE that the first PRS resource set transmission instance from the third TRP and the fourth TRP is muted.

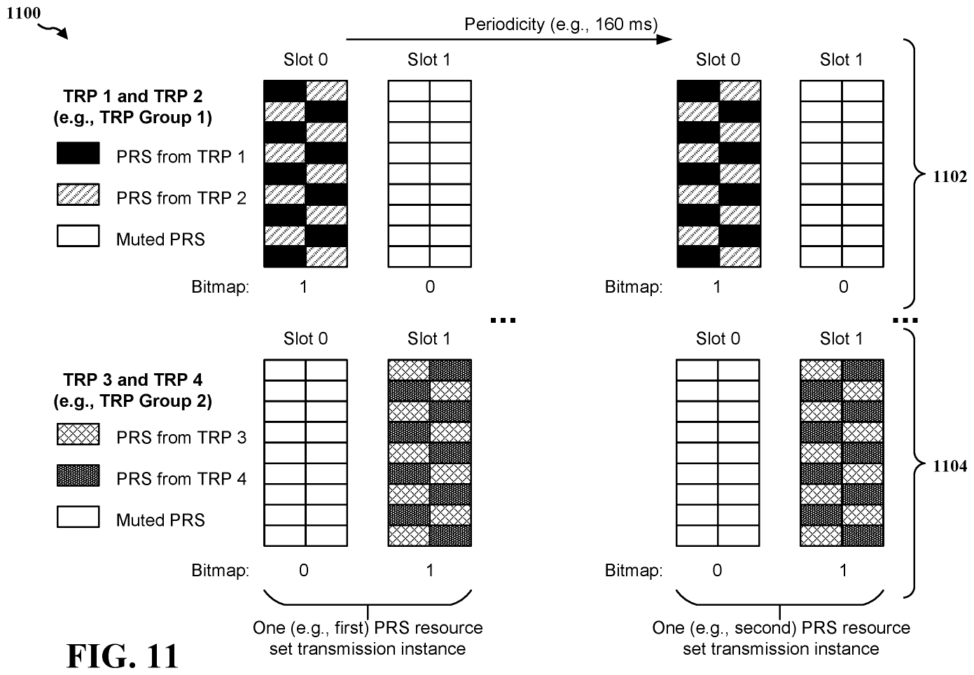

FIG. 11 is a diagram 1100 illustrating an example of PRS muting based on intra-instance muting in accordance with various aspect of the present disclosure. An LMF or a serving base station may configure a set of PRS resources with a comb-2/2-symbol configuration (e.g., as described in connection with FIG. 5A) and with a PRS repetition factor of two (e.g., PRS-ResourceRepetitionFactor=2) to be transmitted from a first TRP, a second TRP, a third TRP, and a fourth TRP to a UE.

Under the intra-instance muting, PRS muting may apply within each transmission instance of a PRS resource set. For example, the base station/LMF may configure different TRPs or different groups of TRPs to mute at different PRS transmission occasions to reduce interference between TRPs (e.g., one PRS resource set transmission instance may include multiple PRS transmission occasions). For example, at a first PRS transmission occasion of a first PRS resource set transmission instance (e.g., at slot zero), the base station/LMF may configure the first TRP and the second TRP to transmit their PRSs and mute PRS transmissions from the third TRP and the fourth TRP. Then, at a second PRS transmission occasion of the first PRS resource set transmission instance (e.g., at slot one), the base station/LMF may configure the third TRP and the fourth TRP to transmit their PRSs and mute PRS transmissions from the first TRP and the second TRP.

The base station may indicate the muted PRS resources to the UE via a bitmap, where each bit in the bitmap may correspond to a single repetition of the PRS resource within an instance of a PRS resource set. For example, as shown at 1102, the base station may determine to transmit two PRS repetitions to a UE via the first TRP and the second TRP in a first PRS resource set transmission instance using slot zero (0) and slot one (1). If the base station determines to mute one of the PRS repetitions, such as the second PRS repetition transmitted at slot one, the base station may transmit a bitmap of {1,0} to the UE to inform the UE that the second PRS repetition in the first PRS resource set transmission instance from the first TRP and the second TRP is muted (e.g., transmitted with zero-power). As such, the UE may skip monitoring for the second PRS repetition transmitted from the first TRP and the second TRP in the first PRS resource set transmission instance. Similarly, as shown at 1104, If the base station determines to mute the first PRS repetition transmitted at slot zero, the base station may transmit a bitmap of {0,1} to the UE to inform the UE that the first PRS repetition in the first PRS resource set transmission instance from the first TRP and the second TRP is muted.

In some scenarios, the intra-instance muting may be more suitable for UE positioning compared to the inter-instance muting as the UE may be able to measure one PRS repetition from each TRP in orthogonal resources in one PRS resource set transmission instance. For example, as shown by the diagram 1000 of FIG. 10, when inter-instance muting is applied, a UE may measure PRSs transmitted from the first TRP and the second TRP in the first PRS resource set transmission instance, but the UE may not be able to measure PRSs transmitted from the third TRP and the fourth TRP in the first PRS resource set transmission instance. Similarly, the UE may measure PRSs transmitted from the third TRP and the fourth TRP in the second PRS resource set transmission instance, but the UE may not be able to measure PRSs transmitted from the first TRP and the second TRP in the second PRS resource set transmission instance. As such, for the UE to complete measuring PRSs transmitted from all four TRPs, it may take at least two PRS resource set transmission instances. In addition, the transmission instances may also be configured with a periodicity (e.g., 160 ms), which may further increase the latency of the PRS measurements across transmission instances. On the other hand, as shown by the diagram 1100 of FIG. 11, when intra-instance muting is applied, a UE may measure one PRS repetition transmitted from the first TRP and the second TRP (e.g., at slot zero) and one PRS repetition transmitted from the first TRP and the second TRP (e.g., at slot one) in one PRS resource set transmission instance, which greatly reduce the latency of the PRS measurements.

Due to an increased amount of bandwidth (BW) being allocated for cellular communications system (e.g., 5G and beyond) and an increased amount of applications (e.g., use cases) being introduced with cellular communications systems, a joint communication and RF sensing may become an important feature for cellular systems. For example, a wireless device (e.g., an RF sensing node, a TRP, a UE, etc.) may be configured to transmit communication signals with radar signals together or simultaneously. In addition, OFDM waveform (or its variants) may likely be considered as the waveform for joint communication/RF sensing as the OFDM waveform may enable in-band multiplexing with other cellular reference signals and physical channels. Thus, radar signals may be multiplexed with communication signals. On the other hand, for a group of wireless devices (e.g., RF sensing nodes, TRPs, UEs, radar transmitters, etc.) to perform RF sensing, such as described in connection with FIG. 8, reference signals (e.g., PRSs, RRSs) transmitted from different wireless devices may not collide in time and/or frequency. In addition, the wireless devices may also be specified to transmit their RRSs over a long period of time with time-domain gaps in between (e.g., to ensure phase continuity for Doppler estimation).

Aspects presented herein may enhance the efficiency and performance of RF sensing schemes/mechanisms based at least in part on time and frequency domain muting, where one or more wireless devices (e.g., RF sensing nodes, TRPs, UEs, etc.) may be configured to mute at least a portion of their respective RRS transmissions to reduce interference with other communication/radar signals and/or for achieving additional power saving. In some examples, PRS muting mechanisms described in connection with FIGS. 10 and 11 may not be suitable for muting RRS. For example, the inter-instance PRS muting described in connection with FIG. 10 may provide a large latency as it may take multiple transmission instances to transmit PRSs from all TRPs, and the intra-instance PRS muting described in connection with FIG. 11 may not be used for muting RRS as the unmuted PRS repetitions are not contiguous in time. As such, aspects presented herein also provide improved RRS muting schemes/mechanisms that may have a shorter latency (compared to the PRS muting) and may enable a wireless to transmit RRS contiguous in time. Thus, aspects presented herein may provide enhanced schemes for RRS transmission across multiple radar transmissions for RF sensing.

In one aspect of the present disclosure, one or more RRS transmissions from wireless devices (e.g., RF sensing nodes, TRPs, UEs) may be muted based on sub-bands, such that a sub-band (e.g., a portion) of RRS transmitted from the one or more devices in a slot may be muted. In addition, different wireless devices or different groups of wireless devices may be configured to mute different sub-bands in a slot, such that all wireless devices may transmit their corresponding RRS with one RRS transmission instance.

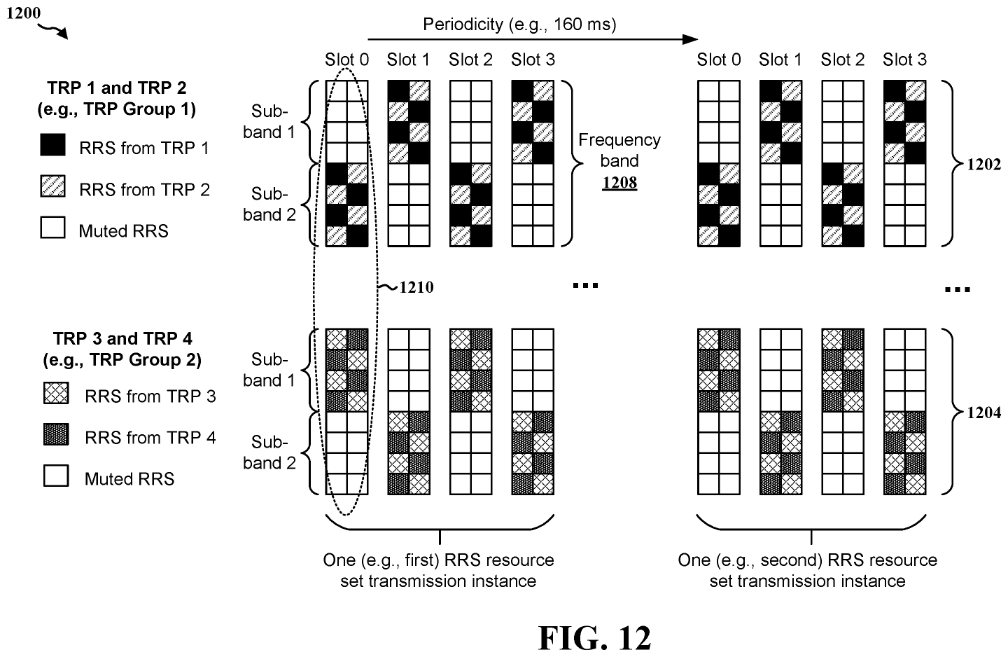

FIG. 12 is a diagram 1200 illustrating an example of sub-band RRS muting in accordance with various aspects of the present disclosure. A base station or an LMF may configure a set of RRS resources or RRS repetitions to be transmitted from a first TRP (TRP 1), a second TRP (TRP 2), a third TRP (TRP 3), and a fourth TRP (TRP 4) (collectively as “TRPs”). In some examples, the TRPs may be in groups. For example, the first TRP and the second TRP may belong to a first TRP group (TRP Group 1) and the third TRP and the fourth TRP may belong to a second TRP group (TRP Group 2). For purposes of the present disclosure, each TRP may be referred to as a “radar transmitter” and/or a “radar Tx” and an entity that receives an RRS from a TRP may be referred to as a “radar receiver” and/or a “radar Rx.” Each repetition of RRS being transmitted by one or more radar Tx may be referred to as an RRS transmission occasion or simply a transmission occasion, and each set of RRS (e.g., for a RF sensing session) being transmitted by one or more radar Tx may be referred to as an RRS resource set transmission instance or simply a transmission instance. While the examples here show TRPs as entity for transmitting radar signals (e.g., for performing RF sensing), the radar Tx may also be a UE, a base station, or a radar device.

In one example, as shown at 1202 and 1204, a time and frequency domain muting pattern for RRS may be defined for the TRPs for each RRS resource set transmission instance (e.g., over multiple slots or symbols), where a frequency band 1208 may be configured for the TRPs for transmitting their corresponding RRSs. In one example, as shown at 1202, the base station/LMF may configure the first TRP and the second TRP to alternatively mute (e.g., transmit with zero-power) between a first sub-band (sub-band 1) and a second sub-band (sub-band 2) of the frequency band 1208 for different transmission occasions in one RRS resource set transmission instance. As such, the RRS muting may be based on intra-instance muting, such as described in connection with FIG. 11. For example, the first TRP and the second TRP may be configured to mute the first sub-band of the frequency band 1208 for slot zero (0), mute the second sub-band of the frequency band 1208 for slot one (1), mute the first sub-band of the frequency band 1208 for slot two (2), mute the second sub-band of the frequency band 1208 for slot three (3), and so on. Similarly, as shown at 1204, the base station/LMF may configure the third TRP and the fourth TRP to alternatively mute between the first sub-band and the second sub-band of the frequency band 1208 for different slots in the RRS resource set transmission instance. However, the sub-band that is being muted may be different from the first TRP and the second TRP for each slot. For example, the third TRP and the fourth TRP may be configured to mute the second sub-band of the frequency band 1208 for slot zero (0), mute the first sub-band of the frequency band 1208 for slot one (1), mute the second sub-band of the frequency band 1208 for slot two (2), mute the first sub-band of the frequency band 1208 for slot three (3), and so on. As such, as shown at 1210, all TRPs (or all groups of TRPs) may transmit their corresponding RRS using some of the resources from the frequency band 1208 in a transmission occasion of the RRS resource set transmission instance, which may enable a radar Rx (e.g., a UE or an object to be detected) to receive and/or measure multiple RRS repetitions from each of the TRPs in orthogonal resources in one RRS resource set transmission instance. Also, the RRS muting configured across the TRPs (e.g., a group of radar Tx) may avoid resource collisions between RRSs transmitted from different TRPs in time and frequency domain.

In addition, the time domain muting configuration may be at slot level or at symbol level. For example, each RRS repetition may be transmitted using one or more symbols and a sub-band of the one or more symbols may be muted. If the RRS repetitions are transmitted based on symbol level, then multiple RRSs may be configured within a slot. Symbol level RRS muting may be suitable for high-speed target detection and tracking.

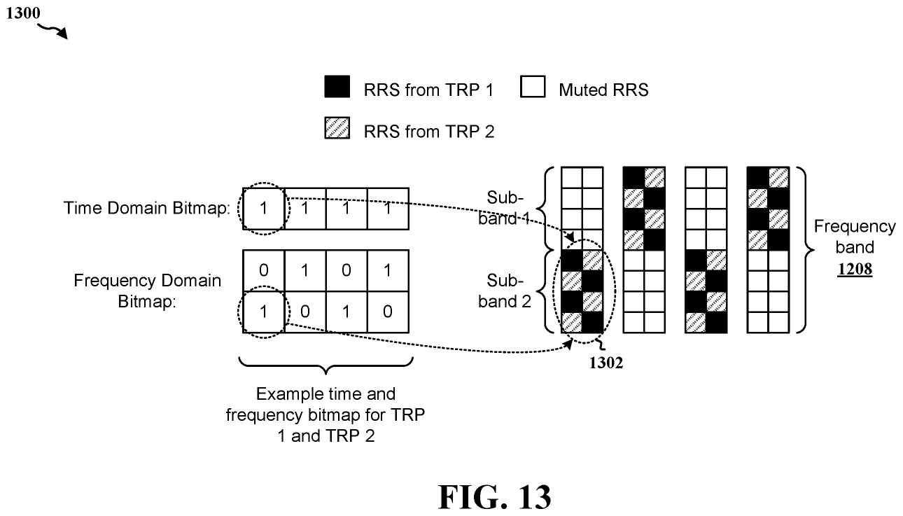

In one example, as shown by a diagram 1300 of FIG. 13, a two-dimensional (2D) bitmap may be defined for the RRS muting pattern (e.g., by the base station or the LMF), such that the TRPs or a radar Rx may determine which sub-band of the frequency band 1208 is to be muted or transmitted. For example, a time and frequency domain bitmap may be used for indicating the muted RRS sub-band, where bit zero (bit=0) for the time domain may indicate that no RRS is to be transmitted in a slot and bit one (bit=1) may indicate that RRS is to be transmitted in that slot, and bit zero (bit=0) for the frequency domain may indicate that no RRS is to be transmitted in a sub-band of a slot and bit one (bit=1) may indicate that RRS is to be transmitted in a sub-band (e.g., sub-band 1 or sub-band 2) of the slot. As such, as shown at 1302, if time domain bitmap and frequency domain bitmap both correspond to bit one, a specific sub-band at specific time may be allowed to be transmitted from a TRP. If at least one of the time domain or the frequency domain has a bit zero, then a specific sub-band at a specific time may not be allowed for RRS transmission. In other words, the two-dimensional (2D) bitmap may include one dimension that is associated with a frequency domain and another dimension that is associated with a time domain.

In some scenarios, the TRPs may be configured to maintain the same transmission power for transmitting the RRSs within an RRS instance, such as to avoid phase jump due to power amplifier (PA) state change. However, if the transmission power for transmitting the RRSs is changing within an instance, one or more common RRS resources (which may also be referred to as RRS tones) may be specified for phase jump estimation.

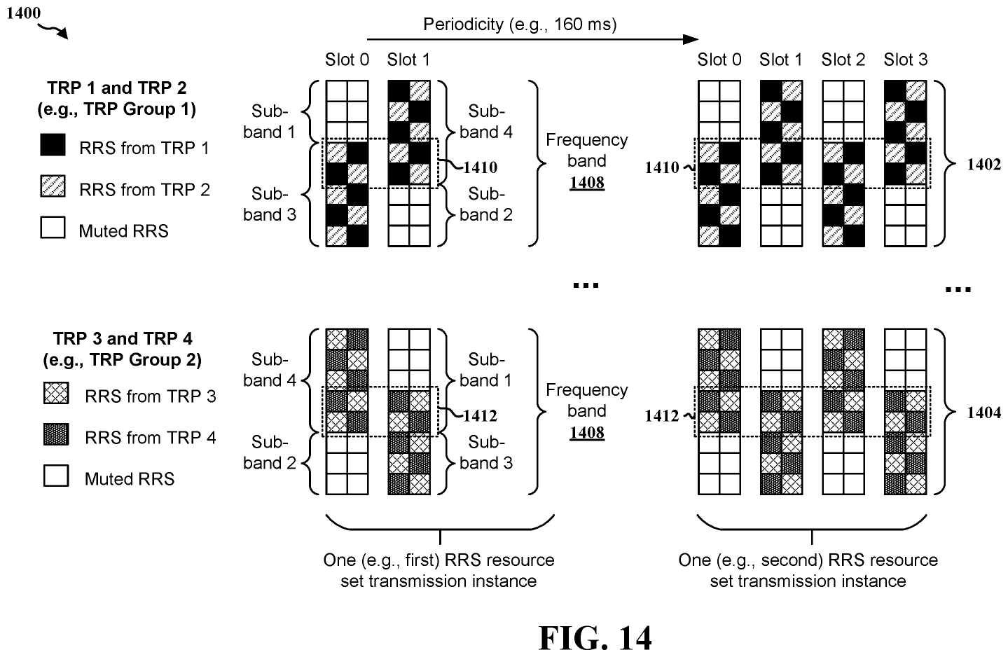

FIG. 14 is a diagram 1400 illustrating an example of sub-band RRS muting with one or more common RRS resources in accordance with various aspects of the present disclosure. A base station or an LMF may configure a set of RRS resources or RRS repetitions to be transmitted from a first TRP (TRP 1), a second TRP (TRP 2), a third TRP (TRP 3), and a fourth TRP (TRP 4) (collectively as “TRPs”). In some examples, the TRPs may be in groups. For example, the first TRP and the second TRP may belong to a first TRP group (TRP Group 1) and the third TRP and the fourth TRP may belong to a second TRP group (TRP Group 2).

In one example, as shown at 1402 and 1404, a time and frequency domain muting pattern for RRS may be defined for the TRPs for each RRS resource set transmission instance (e.g., over multiple slots or symbols), where a frequency band 1408 may be configured for the TRPs for transmitting their corresponding RRSs. In one example, as shown at 1402, the base station/LMF may configure the first TRP and the second TRP to alternatively mute (e.g., transmit with zero-power) between a first sub-band (sub-band 1) and a second sub-band (sub-band 2) of the frequency band 1408 for different transmission occasions in one RRS resource set transmission instance. As such, the RRS muting may be based on intra-instance muting, such as described in connection with FIG. 11. In addition, the base station/LMF may also configure the first TRP and the second TRP to transmit RRSs using one or more common RS resources for each transmission occasion (e.g., for each slot or for each symbol). For example, if the first sub-band of the frequency band 1408 is muted, the first TRP and the second TRP may use other portions of the frequency band 1408 for transmitting the RRS, such as a third sub-band (sub-band 3) as shown by the diagram 1400. If the second sub-band of the frequency band 1408 is muted, the first TRP and the second TRP may use other portions of the frequency band 1408 for transmitting the RRS, such as a fourth sub-band (sub-band 4) as shown by the diagram 1400. Then, the third sub-band and the fourth sub-band may be configured to overlap partially, such that there are common RRS resources for each transmission occasion (e.g., for each slot/symbol) such as shown at 1410. In some examples, the RRS or signal transmitted in the overlapping RRS resource (e.g., the common RRS resources) may have a different sequence or signal type/configuration than the RRS or signal transmitted in the non-overlapping RRS resources (e.g., RRS transmitted using the first sub-band or the second sub-band).

For example, the first TRP and the second TRP may be configured to mute the first sub-band of the frequency band 1408 and transmit RRS on the third sub-band of the frequency band 1408 for slot zero (0), mute the second sub-band of the frequency band 1408 and transmit RRS on the fourth sub-band of the frequency band 1408 for slot one (1), mute the first sub-band of the frequency band 1408 and transmit RRS on the third sub-band of the frequency band 1408 for slot two (2), mute the second sub-band of the frequency band 1408 and transmit RRS on the fourth sub-band of the frequency band 1408 for slot three (3), and so on.

Similarly, as shown at 1404, the base station/LMF may also configure the third TRP and the fourth TRP to alternatively mute (e.g., transmit with zero-power) between the first sub-band and the second sub-band of the frequency band 1408 for different transmission occasions (e.g., slots, symbols) in one RRS resource set transmission instance. However, the sub-band that is being muted may be different from the first TRP and the second TRP for each transmission occasion (e.g., for each slot or symbol). For example, the third TRP and the fourth TRP may be configured to mute the second sub-band of the frequency band 1408 and transmit RRS on the fourth sub-band of the frequency band 1408 for slot zero (0), mute the first sub-band of the frequency band 1408 and transmit RRS on the third sub-band of the frequency band 1408 for slot one (1), mute the second sub-band of the frequency band 1408 and transmit RRS on the fourth sub-band of the frequency band 1408 for slot two (2), mute the first sub-band of the frequency band 1408 and transmit RRS on the third sub-band of the frequency band 1408 for slot three (3), and so on. As such, as shown at 1412, one or more common RRS resources may be used for transmitting the RRS by both the third TRP and the fourth TRP for each transmission occasion. Under such configuration, a radar Rx (e.g., a UE or an object to be detected) may be able to receive and/or measure multiple RRS repetitions from each of the TRPs in orthogonal resources in one RRS resource set transmission instance. Also, the RRS muting configured across the TRPs (e.g., a group of radar Tx) may avoid resource collisions between RRSs transmitted from different TRPs in time and frequency domain.

Similarly, the RRS muting configuration may be at slot level or at symbol level. For example, each RRS repetition may be transmitted using one or more symbols and a sub-band of the one or more symbols may be muted. If the RRS repetitions are transmitted based on symbol level, then multiple RRSs may be configured within a slot.

In addition, a bitmap may be defined for the RRS muting pattern (e.g., by the base station or the LMF), such that the TRPs or a radar Rx may determine which sub-band of the frequency band 1408 is to be muted or transmitted, such as described in connection with FIG. 14. For example, a time and frequency domain bitmap may be used for indicating the muted RRS sub-band, where bit zero (bit=0) for the time domain may indicate that no RRS is to be transmitted in a slot and bit one (bit=1) may indicate that RRS is to be transmitted in that slot, and bit zero (bit=0) for the frequency domain may indicate that no RRS is to be transmitted in a sub-band of a slot and bit one (bit=1) may indicate that RRS is to be transmitted in a sub-band (e.g., sub-band 1 or sub-band 2) of the slot. As such, as shown at 1302, if time domain bitmap and frequency domain bitmap both correspond to bit one, a specific sub-band at specific time may be allowed to be transmitted from a TRP. If at least one of the time domain or the frequency domain has a bit zero, then a specific sub-band at a specific time may not be allowed for RRS transmission.

By configuring common RRS resources for each TRP to transmit RRS in each transmission occasion, phase jump based PA state change may be estimated (e.g., by a radar Rx).

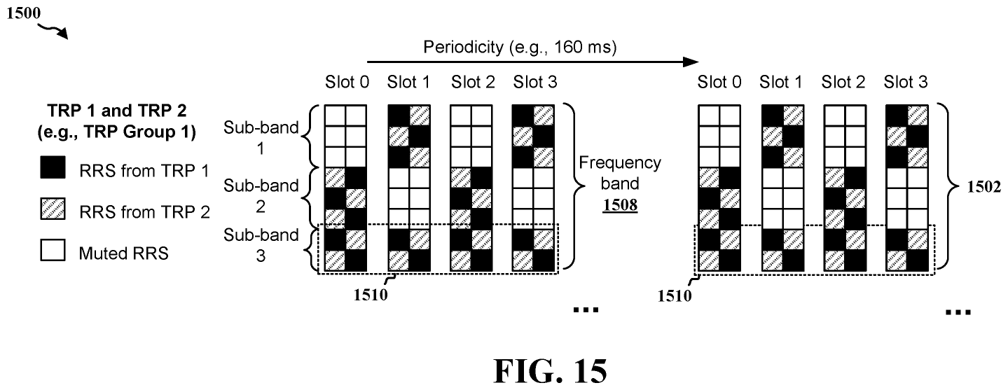

FIG. 15 is a diagram 1500 illustrating another example of sub-band RRS muting with one or more common RRS resources in accordance with various aspects of the present disclosure. Instead of configuring different RRS transmission occasions to partially overlap with each other in frequency as described in connection with FIG. 14, a dedicated common RRS resources may be configured for the TRPs.

For example, as shown at 1502, a time and frequency domain muting pattern for RRS may be defined for the first TRP and the second TRP for each RRS resource set transmission instance (e.g., over multiple slots or symbols), where a frequency band 1508 may be configured for the first TRP and the second TRP for transmitting their corresponding RRSs. For example, the base station/LMF may configure the first TRP and the second TRP to alternatively mute (e.g., transmit with zero-power) between a first sub-band (sub-band 1) and a second sub-band (sub-band 2) of the frequency band 1508 for different transmission occasions in one RRS resource set transmission instance. As such, the RRS muting may be based on intra-instance muting, such as described in connection with FIG. 11. In addition, as shown at 1510, the base station/LMF may also configure the first TRP and the second TRP to transmit RRSs using one or more common RS resources at a third sub-band (Sub-band) for each transmission occasion (e.g., for each slot or for each symbol). For example, the first TRP and the second TRP may be configured to mute the first sub-band of the frequency band 1508 and transmit RRS on the second-band and the third sub-band of the frequency band 1508 for slot zero (0), mute the second sub-band of the frequency band 1508 and transmit RRS on the first sub-band and the third sub-band of the frequency band 1508 for slot one (1), mute the first sub-band of the frequency band 1508 and transmit RRS on the second sub-band and the third sub-band of the frequency band 1508 for slot two (2), mute the second sub-band of the frequency band 1508 and transmit RRS on the first sub-band and the third sub-band of the frequency band 1508 for slot three (3), and so on. In other words, the first TRP and the second TRP may be configured to transmit on the dedicated common RRS resources (e.g., the third sub-band) for each transmission occasion regardless which portion of the frequency band 1508 is being muted. In some examples, the RRS or signal transmitted in the common RRS resources (e.g., the third sub-band) may have a different sequence or signal type/configuration than the RRS or signal transmitted in the non-common RRS resources (e.g., RRS transmitted using the first sub-band or the second sub-band).

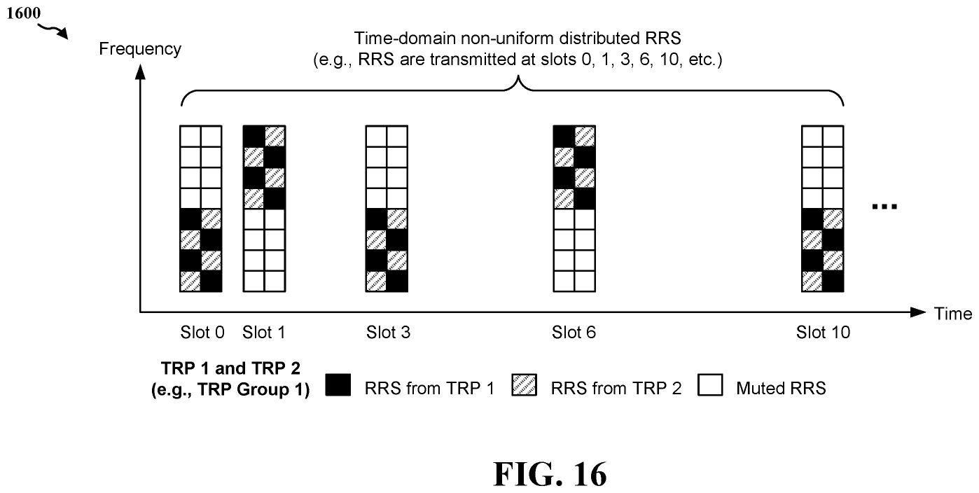

In some scenarios, as shown by a diagram 1600 of FIG. 16, the time domain RRS muting may be non-uniformly configured for the TRPs to remove the alias in Doppler estimation. This is mainly due to the RRS may be non-uniformly configured to remove the alias in Doppler estimation, in the meanwhile some RRS may be avoided to enhance the system spectrum efficiency.

In another aspect of the present disclosure, instead of configuring multiple radar Tx (e.g., TRPs) to transmit RRSs with RRS muting, one or more radar Tx may also be configured to transmit RRSs based on frequency hopping, which may also be referred to as RRS hopping for purposes of the present disclosure. For example, under RRS hopping, one or more TRPs may be configured to transmit their corresponding RRSs using a different frequency band for each RRS transmission occasion (e.g., a slot or one or more symbols). In other words, instead of transmitting RRSs using a single frequency band, the TRPs may transmit the RRSs using multiple frequency bands. For example, a TRP may transmit RRS at a first slot using a first frequency band, at a second slot using a second frequency band, at a third slot using a third frequency band (or use the first frequency band again), etc. In other words, RRS hopping may be a transmission technique in which the RRS may be modulated by a narrowband carrier signal which changes frequency (“hops”) over a wide band of frequencies.

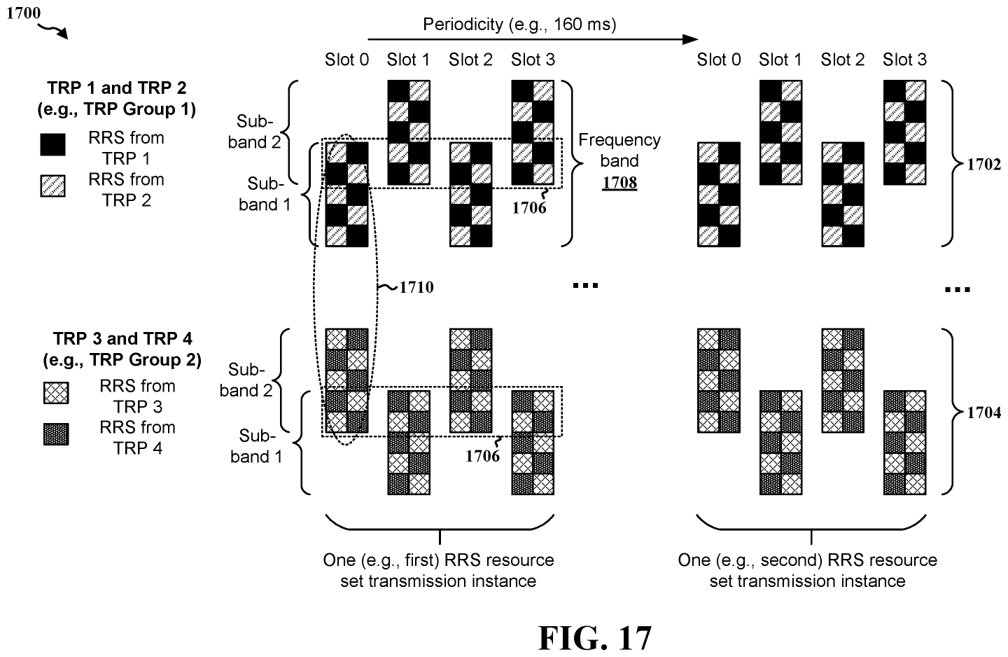

FIG. 17 is a diagram 1700 illustrating an example of an RRS hopping in accordance with various aspects of the present disclosure. A base station or an LMF may configure a set of RRS resources or RRS repetitions to be transmitted from a first TRP (TRP 1), a second TRP (TRP 2), a third TRP (TRP 3), and a fourth TRP (TRP 4) (collectively as “TRPs”). In some examples, the TRPs may be in groups. For example, the first TRP and the second TRP may belong to a first TRP group (TRP Group 1) and the third TRP and the fourth TRP may belong to a second TRP group (TRP Group 2).

In one example, as shown at 1702 and 1704, a time and frequency domain hopping pattern for RRS may be defined/configured for the TRPs for each RRS resource set transmission instance (e.g., over multiple slots or symbols), where a frequency band 1708 may be configured for the TRPs for transmitting their corresponding RRSs. The base station/LMF may also indicate the configured RRS hopping pattern to a radar Rx (e.g., a UE).

In one example, as shown at 1702, the base station/LMF may configure the first TRP and the second TRP to hop (e.g., transmit) between a first sub-band (sub-band 1) and a second sub-band (sub-band 2) of the frequency band 1708 for different transmission occasions in one RRS resource set transmission instance. As such, the RRS hopping may be referred to as an intra-instance hopping. In addition, the base station/LMF may also configure the first sub-band and the second sub-band to overlap at least in part, such that the first TRP and the second TRP may transmit their corresponding RRSs using one or more common/overlapping RS resources for each transmission occasion (e.g., for each slot or for each symbol), such as described in connection with FIG. 14. In some examples, the RRS or signal transmitted in the common/overlapping RRS resource (e.g., the common RRS resources) may have a different sequence or signal type/configuration than the RRS or signal transmitted in the non-common/overlapping RRS resources.

For example, the first TRP and the second TRP may be configured to transmit RRS on the first sub-band of the frequency band 1708 for slot zero (0), transmit RRS on the second sub-band of the frequency band 1708 for slot one (1), to transmit RRS on the first sub-band of the frequency band 1708 for slot two (2), transmit RRS on the second sub-band of the frequency band 1708 for slot three (3), and so on. Similarly, as shown at 1704, the base station/LMF may also configure the third TRP and the fourth TRP to hop between the first sub-band and the second sub-band of the frequency band 1708 for different transmission occasions (e.g., slots, symbols) in one RRS resource set transmission instance. However, the sub-band that is used for transmitting the RRS by the third TRP and the fourth TRP may be different from the first TRP and the second TRP for each transmission occasion (e.g., but there may be some overlap). For example, the third TRP and the fourth TRP may be configured to transmit RRS on the second sub-band of the frequency band 1708 for slot zero (0), transmit RRS on the first sub-band of the frequency band 1708 for slot one (1), to transmit RRS on the second sub-band of the frequency band 1708 for slot two (2), transmit RRS on the first sub-band of the frequency band 1708 for slot three (3), and so on. As such, as shown at 1710, all TRPs may transmit their corresponding RRS using some of the resources from the frequency band 1708 in a transmission occasion of the RRS resource set transmission instance, which may enable a radar Rx (e.g., a UE or an object to be detected) to receive and/or measure multiple RRS repetitions from each of the TRPs in orthogonal resources in one RRS resource set transmission instance. In addition, the RRS hoping configured across the TRPs (e.g., a group of radar Tx) may avoid resource collisions between RRSs transmitted from different TRPs in time and frequency domain (except the common RRS resources).

Similarly, as shown at 1706, one or more common RRS resources may be used for transmitting the RRS by the TRPs, such as described in connection with FIGS. 14 and 15. The common RRS resources may help a radar Rx (e.g., a UE) to estimate any phase jump across the RRS hopping. In some examples, the common RRS resources may be punctured by the radar Rx for target detection and/or for parameter estimation.

The RRS hopping configuration may be at slot level or at symbol level. For example, each RRS repetition may be transmitted using one or more symbols. If the RRS repetitions are transmitted based on symbol level, then multiple RRSs may be configured within a slot. If multiple RRS is able to be configured within a slot, a symbol level hopping may also be enabled.

While examples discussed in connection with FIGS. 12 to 17 show RRSs are transmitted from TRPs, the RRSs may also be transmitted from multiple RF sensing nodes, UEs, or a combination thereof. As such, aspects presented herein (e.g., the RRS muting, the RRS hopping) may also apply to any entity that is capable of transmitting RRSs, which may include, an RF sensing node, a UE, a radar device, or a combination thereof.

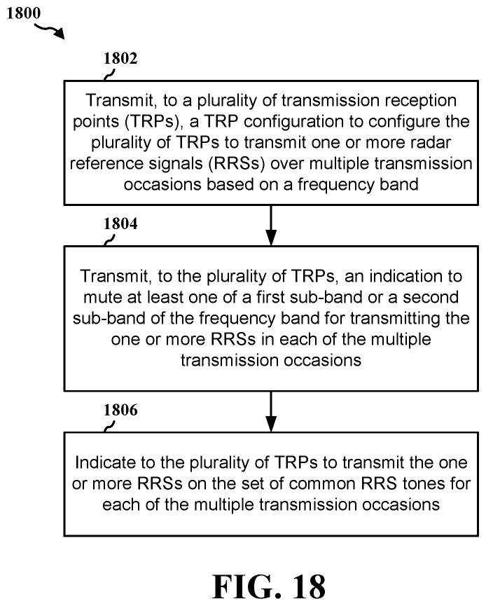

FIG. 18 is a flowchart 1800 of a method of wireless communication. The method may be performed by a base station or a component of a base station (e.g., the base station 102, 180, 310, 704; the TRP 402, 604, 606, 608, 610, 708; the apparatus 2002; a processing system, which may include the memory 376 and which may be the entire base station 310 or a component of the base station 310, such as the TX processor 316 the RX processor 370, and/or the controller/processor 375). The method may enable the base station to mute at least a portion of RRS transmissions from multiple TRPs to enhance the efficiency and performance of RF sensing schemes/mechanisms.

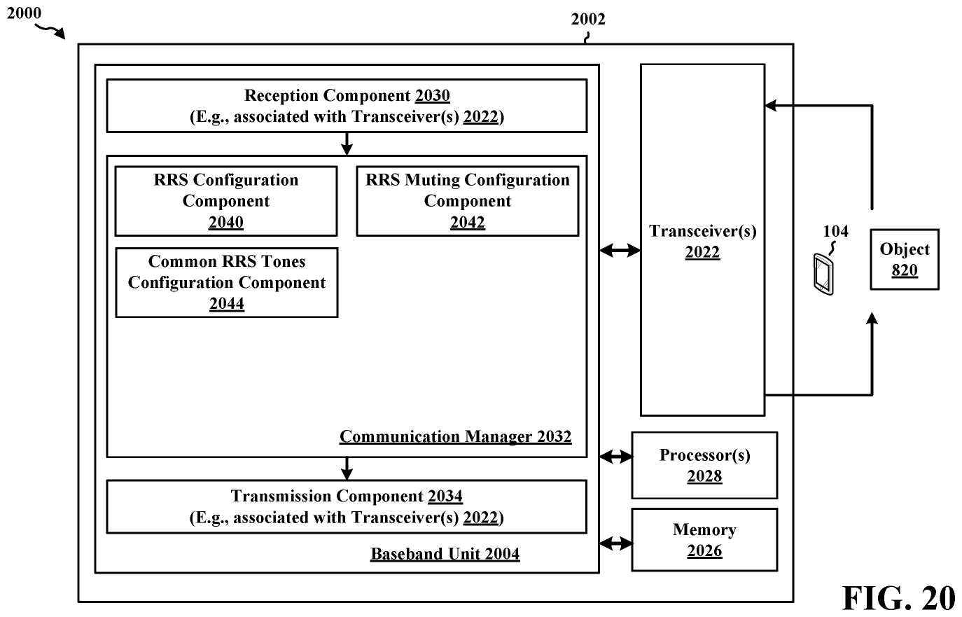

At 1802, the base station may transmit, to a plurality of TRPs, a TRP configuration to configure the plurality of TRPs to transmit one or more RRSs over multiple transmission occasions based on a frequency band, such as described in connection with FIGS. 12 to 16. For example, as shown by the FIG. 12, a base station may configure a first TRP, a second TRP, a third TRP, and a fourth TRP to transmit RRS over multiple slots based on a frequency band 1208. The transmission of the configuration may be performed by, e.g., the RRS configuration component 2040 and/or the transmission component 2034 of the apparatus 2002 in FIG. 20.

In one example, each of the multiple transmission occasions may correspond to one slot or one symbol.

In another example, the configuration further configures the plurality of TRPs to transmit each of the one or more RRSs with a same transmission power.

In another example, the plurality of TRPs are associated with the base station or are part of the base station.

In another example, the multiple transmission occasions may correspond to one radar measurement instance.

At 1804, the base station may transmit, to the plurality of TRPs, an indication to mute at least one of a first sub-band or a second sub-band of the frequency band for transmitting the one or more RRSs in each of the multiple transmission occasions, such as described in connection with FIGS. 12 to 16. For example, as shown by FIG. 12, a base station may configure the first TRP, the second TRP, the third TRP, and the fourth TRP to mute a first sub-band (sub-band 1) or a second sub-band (sub-band 2) of the frequency band 1208 in one or more RRS transmission occasions. The transmission of the indication may be performed by, e.g., the RRS muting configuration component 2042 and/or the transmission component 2034 of the apparatus 2002 in FIG. 20.

In one example, to mute the first sub-band or the second sub-band of the frequency band for transmitting the one or more RRSs, the plurality of TRPs may be configured to transmit the one or more RRSs in the first sub-band or the second sub-band of the frequency band with zero-power.

In another example, the indication may further indicate the plurality of TRPs to switch between muting the first sub-band and muting the second sub-band across the multiple transmission occasions, such that the plurality of TRPs do not mute a same sub-band for two adjacent transmission occasions.

In another example, the indication to mute the first sub-band or the second sub-band of the frequency band for the multiple transmission occasions may include a 2D bitmap, where one dimension of the 2D bitmap may be associated with a frequency domain and another dimension of the 2D bitmap may be associated with a time domain.

In another example, the plurality of TRPs may transmit the one or more RRSs using a third sub-band of the frequency band in a first transmission occasion if the plurality of TRPs mute the first sub-band in the first transmission occasion, and the plurality of TRPs transmits the one or more RRSs using a fourth sub-band of the frequency band in a second transmission occasion if the plurality of TRPs mute the second sub-band in the second transmission occasion. In one example, the third sub-band and the fourth sub-band may not overlap with each other. In another example, the third sub-band may overlap with at least a portion of the fourth sub-band, where the at least a portion of the fourth sub-band corresponds to a set of common RRS tones.

At 1806, the base station may indicate to the plurality of TRPs to transmit the one or more RRSs on the set of common RRS tones for each of the multiple transmission occasions, such as described in connection with FIGS. 14 and 15. For example, as shown at 1412 of FIG. 14, one or more common RRS resources may be used for transmitting the RRS by both the third TRP and the fourth TRP for each transmission occasion. The indication of the set of common RRS tones may be performed by, e.g., the common RRS tones configuration component 2044 and/or the transmission component 2034 of the apparatus 2002 in FIG. 20.

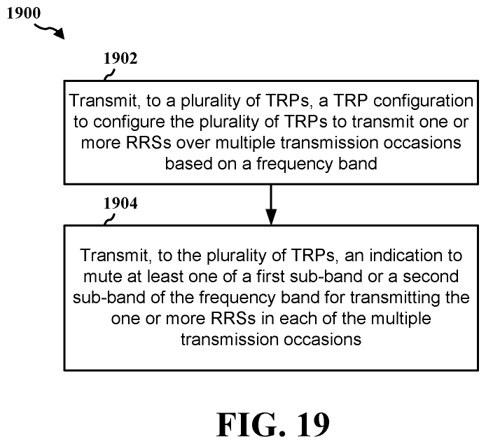

FIG. 19 is a flowchart 1900 of a method of wireless communication. The method may be performed by a base station or a component of a base station (e.g., the base station 102, 180, 310, 704; the TRP 402, 604, 606, 608, 610, 708; the apparatus 2002; a processing system, which may include the memory 376 and which may be the entire base station 310 or a component of the base station 310, such as the TX processor 316 the RX processor 370, and/or the controller/processor 375). The method may enable the base station to mute at least a portion of RRS transmissions from multiple TRPs to enhance the efficiency and performance of RF sensing schemes/mechanisms.

At 1902, the base station may transmit, to a plurality of TRPs, a TRP configuration to configure the plurality of TRPs to transmit one or more RRSs over multiple transmission occasions based on a frequency band, such as described in connection with FIGS. 12 to 16. For example, as shown by the FIG. 12, a base station may configure a first TRP, a second TRP, a third TRP, and a fourth TRP to transmit RRS over multiple slots based on a frequency band 1208. The transmission of the configuration may be performed by, e.g., the RRS configuration component 2040 and/or the transmission component 2034 of the apparatus 2002 in FIG. 20.

In one example, each of the multiple transmission occasions may correspond to one slot or one symbol.

In another example, the configuration further configures the plurality of TRPs to transmit each of the one or more RRSs with a same transmission power.

In another example, the plurality of TRPs are associated with the base station or are part of the base station.

In another example, the multiple transmission occasions may correspond to one radar measurement instance.

At 1904, the base station may transmit, to the plurality of TRPs, an indication to mute at least one of a first sub-band or a second sub-band of the frequency band for transmitting the one or more RRSs in each of the multiple transmission occasions, such as described in connection with FIGS. 12 to 16. For example, as shown by FIG. 12, a base station may configure the first TRP, the second TRP, the third TRP, and the fourth TRP to mute a first sub-band (sub-band 1) or a second sub-band (sub-band 2) of the frequency band 1208 in one or more RRS transmission occasions. The transmission of the indication may be performed by, e.g., the RRS muting configuration component 2042 and/or the transmission component 2034 of the apparatus 2002 in FIG. 20.

In one example, to mute the first sub-band or the second sub-band of the frequency band for transmitting the one or more RRSs, the plurality of TRPs may be configured to transmit the one or more RRSs in the first sub-band or the second sub-band of the frequency band with zero-power.

In another example, the indication may further indicate the plurality of TRPs to switch between muting the first sub-band and muting the second sub-band across the multiple transmission occasions, such that the plurality of TRPs do not mute a same sub-band for two adjacent transmission occasions.

In another example, the indication to mute the first sub-band or the second sub-band of the frequency band for the multiple transmission occasions may include a 2D bitmap, where one dimension of the 2D bitmap may be associated with a frequency domain and another dimension of the 2D bitmap may be associated with a time domain.

In another example, the plurality of TRPs may transmit the one or more RRSs using a third sub-band of the frequency band in a first transmission occasion if the plurality of TRPs mute the first sub-band in the first transmission occasion, and the plurality of TRPs transmits the one or more RRSs using a fourth sub-band of the frequency band in a second transmission occasion if the plurality of TRPs mute the second sub-band in the second transmission occasion. In one example, the third sub-band and the fourth sub-band may not overlap with each other. In another example, the third sub-band may overlap with at least a portion of the fourth sub-band, where the at least a portion of the fourth sub-band corresponds to a set of common RRS tones.

In another example, the base station may indicate to the plurality of TRPs to transmit the one or more RRSs on the set of common RRS tones for each of the multiple transmission occasions, such as described in connection with FIGS. 14 and 15. For example, as shown at 1412 of FIG. 14, one or more common RRS resources may be used for transmitting the RRS by both the third TRP and the fourth TRP for each transmission occasion. The indication of the set of common RRS tones may be performed by, e.g., the common RRS tones configuration component 2044 and/or the transmission component 2034 of the apparatus 2002 in FIG. 20.

FIG. 20 is a diagram 2000 illustrating an example of a hardware implementation for an apparatus 2002. The apparatus 2002 may be a base station, a component of a base station, or may implement base station functionality. In some aspects, the apparatus 2002 may include a baseband unit 2004. The baseband unit 2004 may communicate through at least one transceiver 2022 (e.g., one or more RF transceivers and/or antennas) with the UE 104 or with an object 820 (e.g., an object that receives and/or bounce off RF sensing signals). The at least one transceiver 2022 may be associated with or include a reception component 2030 and/or a transmission component 2034. The baseband unit 2004 may include a computer-readable medium/memory (e.g., a memory 2026). The baseband unit 2004 and/or the at least one processor 2028 may be responsible for general processing, including the execution of software stored on the computer-readable medium/memory. The software, when executed by the baseband unit 2004 and/or the at least one processor 2028, causes the baseband unit 2004 and/or the at least one processor 2028 to perform the various functions described supra. The computer-readable medium/memory may also be used for storing data that is manipulated by the baseband unit 2004 when executing software. The baseband unit 2004 further includes the reception component 2030, a communication manager 2032, and the transmission component 2034. The reception component 2030 and the transmission component 2034 may, in a non-limiting example, include at least one transceiver and/or at least one antenna subsystem. The communication manager 2032 includes the one or more illustrated components. The components within the communication manager 2032 may be stored in the computer-readable medium/memory and/or configured as hardware within the baseband unit 2004. The baseband unit 2004 may be a component of the base station and may include the memory 376 and/or at least one of the TX processor 316, the RX processor 370, and the controller/processor 375.

The communication manager 2032 includes an RRS configuration component 2040 that transmits, to a plurality of TRPs, a TRP configuration to configure the plurality of TRPs to transmit one or more RRSs over multiple transmission occasions based on a frequency band, e.g., as described in connection with 1802 of FIGS. 18 and/or 1902 of FIG. 19. The communication manager 2032 further includes an RRS muting configuration component 2042 that transmits, to the plurality of TRPs, an indication to mute at least one of a first sub-band or a second sub-band of the frequency band for transmitting the one or more RRSs in each of the multiple transmission occasions, e.g., as described in connection with 1804 of FIGS. 18 and/or 1904 of FIG. 19. The communication manager 2032 further includes a common RRS tones configuration component 2044 that indicates to the plurality of TRPs to transmit the one or more RRSs on the set of common RRS tones for each of the multiple transmission occasions, e.g., as described in connection with 1806 of FIG. 18.

The apparatus may include additional components that perform each of the blocks of the algorithm in the flowcharts of FIGS. 18 and 19. As such, each block in the flowcharts of FIGS. 18 and 19 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2002 may include a variety of components configured for various functions. In one configuration, the apparatus 2002, and in particular the baseband unit 2004, includes means for transmitting, to a plurality of TRPs, a TRP configuration to configure the plurality of TRPs to transmit one or more RRSs over multiple transmission occasions based on a frequency band (e.g., the RRS configuration component 2040 and/or the transmission component 2034). The apparatus 2002 includes means for transmitting, to the plurality of TRPs, an indication to mute at least one of a first sub-band or a second sub-band of the frequency band for transmitting the one or more RRSs in each of the multiple transmission occasions (e.g., the RRS muting configuration component 2042 and/or the transmission component 2034). The apparatus 2002 includes means for indicating to the plurality of TRPs to transmit the one or more RRSs on the set of common RRS tones for each of the multiple transmission occasions (e.g., the common RRS tones configuration component 2044 and/or the transmission component 2034).

In one configuration, each of the multiple transmission occasions may correspond to one slot or one symbol.

In another configuration, the configuration further configures the plurality of TRPs to transmit each of the one or more RRSs with a same transmission power.

In another configuration, the plurality of TRPs are associated with the base station or are part of the base station.

In another configuration, the multiple transmission occasions may correspond to one radar measurement instance.

In another configuration, to mute the first sub-band or the second sub-band of the frequency band for transmitting the one or more RRSs, the plurality of TRPs may be configured to transmit the one or more RRSs in the first sub-band or the second sub-band of the frequency band with zero-power.

In another configuration, the indication may further indicate the plurality of TRPs to switch between muting the first sub-band and muting the second sub-band across the multiple transmission occasions, such that the plurality of TRPs do not mute a same sub-band for two adjacent transmission occasions.

In another configuration, the indication to mute the first sub-band or the second sub-band of the frequency band for the multiple transmission occasions may include a 2D bitmap, where one dimension of the 2D bitmap may be associated with a frequency domain and another dimension of the 2D bitmap may be associated with a time domain.

In another configuration, the plurality of TRPs may transmit the one or more RRSs using a third sub-band of the frequency band in a first transmission occasion if the plurality of TRPs mute the first sub-band in the first transmission occasion, and the plurality of TRPs transmits the one or more RRSs using a fourth sub-band of the frequency band in a second transmission occasion if the plurality of TRPs mute the second sub-band in the second transmission occasion. In one configuration, the third sub-band and the fourth sub-band may not overlap with each other. In another configuration, the third sub-band may overlap with at least a portion of the fourth sub-band, where the at least a portion of the fourth sub-band corresponds to a set of common RRS tones.

The means may be one or more of the components of the apparatus 2002 configured to perform the functions recited by the means. As described supra, the apparatus 2002 may include the TX Processor 316, the RX Processor 370, and the controller/processor 375. As such, in one configuration, the means may be the TX Processor 316, the RX Processor 370, and the controller/processor 375 configured to perform the functions recited by the means.

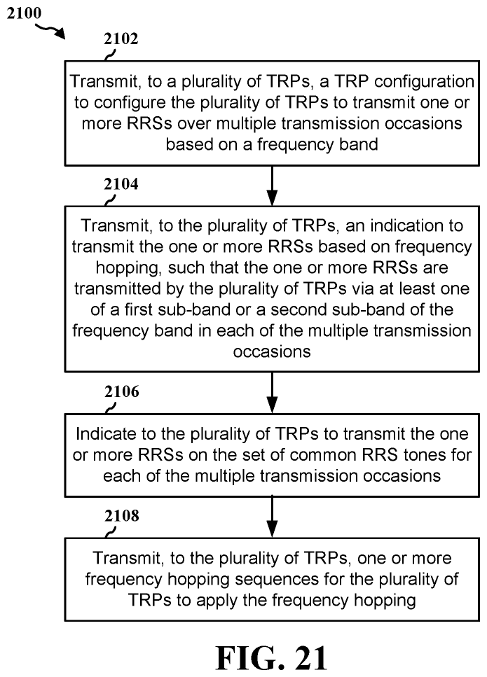

FIG. 21 is a flowchart 2100 of a method of wireless communication. The method may be performed by a base station or a component of a base station (e.g., the base station 102, 180, 310, 704; the TRP 402, 604, 606, 608, 610, 708; the apparatus 2302; a processing system, which may include the memory 376 and which may be the entire base station 310 or a component of the base station 310, such as the TX processor 316 the RX processor 370, and/or the controller/processor 375). The method may enable the base station to apply frequency hopping to RRS transmissions from multiple TRPs to enhance the efficiency and performance of RF sensing schemes/mechanisms.

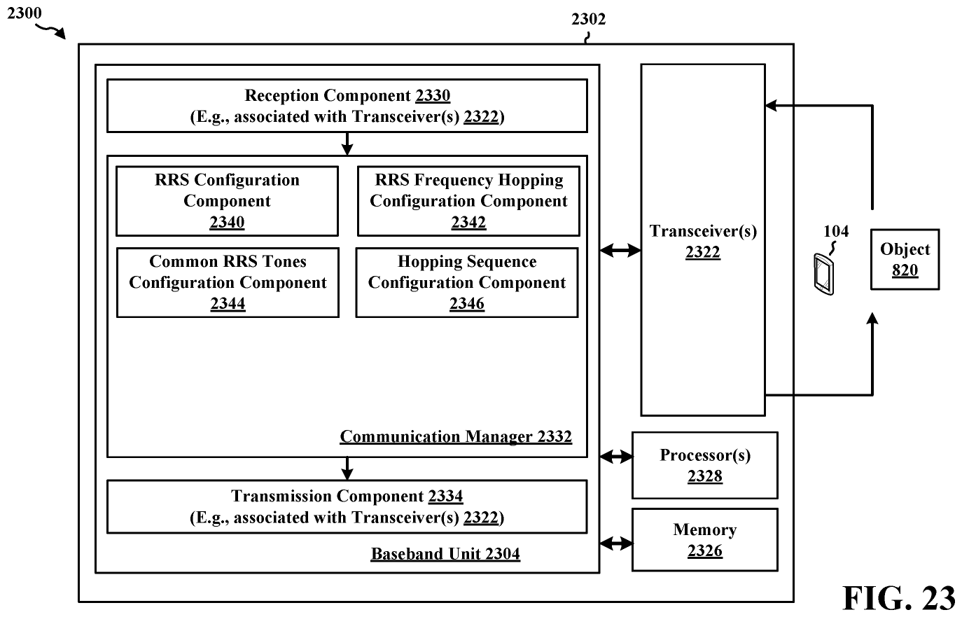

At 2102, the base station may transmit, to a plurality of TRPs, a TRP configuration to configure the plurality of TRPs to transmit one or more RRSs over multiple transmission occasions based on a frequency band, such as described in connection with FIG. 17. For example, as shown by the FIG. 17, a base station may configure a first TRP, a second TRP, a third TRP, and a fourth TRP to transmit RRS over multiple slots based on a frequency band 1208. The transmission of the configuration may be performed by, e.g., the RRS configuration component 2340 and/or the transmission component 2334 of the apparatus 2302 in FIG. 23.

In one example, each of the multiple transmission occasions may correspond to one slot or one symbol.

In another example, the configuration may further configure the plurality of TRPs to transmit each of the one or more RRSs with a same transmission power.

In another example, the plurality of TRPs may be associated with the base station or may be part of the base station.

At 2104, the base station may transmit, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions, such as described in connection with FIG. 17. For example, as shown by FIG. 17, a base station may configure the first TRP, the second TRP, the third TRP, and the fourth TRP to transmit RRSs based on frequency hopping between a first sub-band (sub-band 1) and a second sub-band (sub-band 2) of the frequency band 1208 in one or more RRS transmission occasions. The transmission of the indication may be performed by, e.g., the RRS frequency hopping configuration component 2342 and/or the transmission component 2334 of the apparatus 2302 in FIG. 23.

In one example, the indication may further indicate the plurality of TRPs to switch between transmitting the one or more RRSs using the first sub-band and transmitting the one or more RRSs using the second sub-band across the multiple transmission occasions, such that the plurality of TRPs may not transmit the one or more RRSs using a same sub-band for two adjacent transmission occasions.

In another example, the first sub-band may overlap with at least a portion of the second sub-band, where the at least a portion of the second sub-band may correspond to a set of common RRS tones.

At 2106, the base station may indicate to the plurality of TRPs to transmit the one or more RRSs on the set of common RRS tones for each of the multiple transmission occasions, such as described in connection with FIG. 17. For example, as shown at 1706 of FIG. 17, one or more common RRS resources may be used for transmitting the RRS by both the first TRP and the second TRP or by both the third TRP and the fourth TRP for each transmission occasion. The indication of the set of common RRS tones may be performed by, e.g., the common RRS tones configuration component 2344 and/or the transmission component 2334 of the apparatus 2302 in FIG. 23.

At 2108, the base station may transmit, to the plurality of TRPs, one or more frequency hopping sequences for the plurality of TRPs to apply the frequency hopping, such as described in connection with FIG. 17. For example, a frequency hopping sequence may be transmitted to the first TRP, the second TRP, the third TRP, and the fourth TRP for the TRPs to apply. The transmission of the frequency hopping sequences may be performed by, e.g., the hopping sequence configuration component 2346 and/or the transmission component 2334 of the apparatus 2302 in FIG. 23.

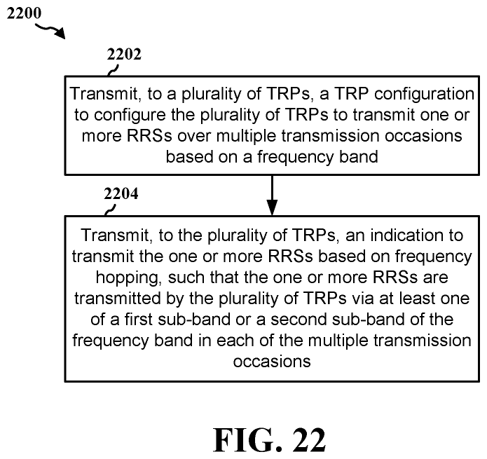

FIG. 22 is a flowchart 2200 of a method of wireless communication. The method may be performed by a base station or a component of a base station (e.g., the base station 102, 180, 310, 704; the TRP 402, 604, 606, 608, 610, 708; the apparatus 2302; a processing system, which may include the memory 376 and which may be the entire base station 310 or a component of the base station 310, such as the TX processor 316 the RX processor 370, and/or the controller/processor 375). The method may enable the base station to apply frequency hopping to RRS transmissions from multiple TRPs to enhance the efficiency and performance of RF sensing schemes/mechanisms.

At 2202, the base station may transmit, to a plurality of TRPs, a TRP configuration to configure the plurality of TRPs to transmit one or more RRSs over multiple transmission occasions based on a frequency band, such as described in connection with FIG. 17. For example, as shown by the FIG. 17, a base station may configure a first TRP, a second TRP, a third TRP, and a fourth TRP to transmit RRS over multiple slots based on a frequency band 1208. The transmission of the configuration may be performed by, e.g., the RRS configuration component 2340 and/or the transmission component 2334 of the apparatus 2302 in FIG. 23.

In one example, each of the multiple transmission occasions may correspond to one slot or one symbol.

In another example, the configuration may further configure the plurality of TRPs to transmit each of the one or more RRSs with a same transmission power.

In another example, the plurality of TRPs may be associated with the base station or may be part of the base station.

At 2204, the base station may transmit, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions, such as described in connection with FIG. 17. For example, as shown by FIG. 17, a base station may configure the first TRP, the second TRP, the third TRP, and the fourth TRP to transmit RRSs based on frequency hopping between a first sub-band (sub-band 1) and a second sub-band (sub-band 2) of the frequency band 1208 in one or more RRS transmission occasions. The transmission of the indication may be performed by, e.g., the RRS frequency hopping configuration component 2342 and/or the transmission component 2334 of the apparatus 2302 in FIG. 23.

In one example, the indication may further indicate the plurality of TRPs to switch between transmitting the one or more RRSs using the first sub-band and transmitting the one or more RRSs using the second sub-band across the multiple transmission occasions, such that the plurality of TRPs may not transmit the one or more RRSs using a same sub-band for two adjacent transmission occasions.

In another example, the first sub-band may overlap with at least a portion of the second sub-band, where the at least a portion of the second sub-band may correspond to a set of common RRS tones.

In another example, the base station may indicate to the plurality of TRPs to transmit the one or more RRSs on the set of common RRS tones for each of the multiple transmission occasions, such as described in connection with FIG. 17. For example, as shown at 1706 of FIG. 17, one or more common RRS resources may be used for transmitting the RRS by both the first TRP and the second TRP or by both the third TRP and the fourth TRP for each transmission occasion. The indication of the set of common RRS tones may be performed by, e.g., the common RRS tones configuration component 2344 and/or the transmission component 2334 of the apparatus 2302 in FIG. 23.

In another example, the base station may transmit, to the plurality of TRPs, one or more frequency hopping sequences for the plurality of TRPs to apply the frequency hopping, such as described in connection with FIG. 17. For example, a frequency hopping sequence may be transmitted to the first TRP, the second TRP, the third TRP, and the fourth TRP for the TRPs to apply. The transmission of the frequency hopping sequences may be performed by, e.g., the hopping sequence configuration component 2346 and/or the transmission component 2334 of the apparatus 2302 in FIG. 23.

FIG. 23 is a diagram 2300 illustrating an example of a hardware implementation for an apparatus 2302. The apparatus 2302 may be a base station, a component of a base station, or may implement base station functionality. In some aspects, the apparatus 2302 may include a baseband unit 2304. The baseband unit 2304 may communicate through at least one transceiver 2322 (e.g., one or more RF transceivers and/or antennas) with the UE 104 or with an object 820 (e.g., an object that receives and/or bounce off RF sensing signals). The at least one transceiver 2322 may be associated with or include a reception component 2330 and/or a transmission component 2334. The baseband unit 2304 may include a computer-readable medium/memory (e.g., a memory 2326). The baseband unit 2304 and/or the at least one processor 2328 may be responsible for general processing, including the execution of software stored on the computer-readable medium/memory. The software, when executed by the baseband unit 2304 and/or the at least one processor 2328, causes the baseband unit 2304 and/or the at least one processor 2328 to perform the various functions described supra. The computer-readable medium/memory may also be used for storing data that is manipulated by the baseband unit 2304 when executing software. The baseband unit 2304 further includes the reception component 2330, a communication manager 2332, and the transmission component 2334. The reception component 2330 and the transmission component 2334 may, in a non-limiting example, include at least one transceiver and/or at least one antenna subsystem. The communication manager 2332 includes the one or more illustrated components. The components within the communication manager 2332 may be stored in the computer-readable medium/memory and/or configured as hardware within the baseband unit 2304. The baseband unit 2304 may be a component of the base station and may include the memory 376 and/or at least one of the TX processor 316, the RX processor 370, and the controller/processor 375.

The communication manager 2332 includes an RRS configuration component 2340 that transmits, to a plurality of TRPs, a TRP configuration to configure the plurality of TRPs to transmit one or more RRSs over multiple transmission occasions based on a frequency band, e.g., as described in connection with 2102 of FIGS. 21 and/or 2202 of FIG. 22. The communication manager 2332 further includes an RRS frequency hopping configuration component 2342 that transmits, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions, e.g., as described in connection with 2104 of FIGS. 21 and/or 2204 of FIG. 22. The communication manager 2332 further includes a common RRS tones configuration component 2344 that indicates to the plurality of TRPs to transmit the one or more RRSs on the set of common RRS tones for each of the multiple transmission occasions, e.g., as described in connection with 2106 of FIG. 21. The communication manager 2332 further includes a hopping sequence configuration component 2346 that transmits, to the plurality of TRPs, one or more frequency hopping sequences for the plurality of TRPs to apply the frequency hopping, e.g., as described in connection with 2108 of FIG. 21.

The apparatus may include additional components that perform each of the blocks of the algorithm in the flowcharts of FIGS. 21 and 22. As such, each block in the flowcharts of FIGS. 21 and 22 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2302 may include a variety of components configured for various functions. In one configuration, the apparatus 2302, and in particular the baseband unit 2304, includes means for transmitting, to a plurality of TRPs, a TRP configuration to configure the plurality of TRPs to transmit one or more RRSs over multiple transmission occasions based on a frequency band (e.g., the RRS configuration component 2340 and/or the transmission component 2334). The apparatus 2302 includes means transmitting, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions (e.g., the RRS frequency hopping configuration component 2342 and/or the transmission component 2334). The apparatus 2302 includes means for indicating to the plurality of TRPs to transmit the one or more RRSs on the set of common RRS tones for each of the multiple transmission occasions (e.g., the common RRS tones configuration component 2344 and/or the transmission component 2334). The apparatus 2302 includes means for transmitting, to the plurality of TRPs, one or more frequency hopping sequences for the plurality of TRPs to apply the frequency hopping (e.g., the hopping sequence configuration component 2346 and/or the transmission component 2334).

In one configuration, each of the multiple transmission occasions may correspond to one slot or one symbol.

In another configuration, the configuration may further configure the plurality of TRPs to transmit each of the one or more RRSs with a same transmission power.

In another configuration, the plurality of TRPs may be associated with the base station or may be part of the base station.

In another configuration, the indication may further indicate the plurality of TRPs to switch between transmitting the one or more RRSs using the first sub-band and transmitting the one or more RRSs using the second sub-band across the multiple transmission occasions, such that the plurality of TRPs may not transmit the one or more RRSs using a same sub-band for two adjacent transmission occasions.

In another configuration, the first sub-band may overlap with at least a portion of the second sub-band, where the at least a portion of the second sub-band may correspond to a set of common RRS tones.

The means may be one or more of the components of the apparatus 2302 configured to perform the functions recited by the means. As described supra, the apparatus 2302 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including a memory; at least one transceiver; and at least one processor communicatively connected to the memory and the at least one transceiver, the at least one processor configured to: transmit, to a plurality of TRPs, a TRP configuration to configure the plurality of TRPs to transmit one or more RRSs over multiple transmission occasions based on a frequency band; and transmit, to the plurality of TRPs, an indication to mute at least one of a first sub-band or a second sub-band of the frequency band for transmitting the one or more RRSs in each of the multiple transmission occasions.

Aspect 2 is the apparatus of aspect 1, where to mute the first sub-band or the second sub-band of the frequency band for transmitting the one or more RRSs, the plurality of TRPs are configured to transmit the one or more RRSs in the first sub-band or the second sub-band of the frequency band with zero-power.

Aspect 3 is the apparatus of any of aspects 1 and 2, where each of the multiple transmission occasions corresponds to one slot or one symbol.

Aspect 4 is the apparatus of any of aspects 1 to 3, where the indication further indicates the plurality of TRPs to switch between muting the first sub-band and muting the second sub-band across the multiple transmission occasions, such that the plurality of TRPs do not mute a same sub-band for two adjacent transmission occasions.

Aspect 5 is the apparatus of any of aspects 1 to 4, where the plurality of TRPs transmits the one or more RRSs using a third sub-band of the frequency band in a first transmission occasion if the plurality of TRPs mute the first sub-band in the first transmission occasion, and the plurality of TRPs transmits the one or more RRSs using a fourth sub-band of the frequency band in a second transmission occasion if the plurality of TRPs mute the second sub-band in the second transmission occasion.

Aspect 6 is the apparatus of any of aspects 1 to 5, where the third sub-band and the fourth sub-band do not overlap with each other.

Aspect 7 is the apparatus of any of aspects 1 to 6, where the third sub-band overlaps with at least a portion of the fourth sub-band, where the at least a portion of the fourth sub-band corresponds to a set of common RRS tones.

Aspect 8 is the apparatus of any of aspects 1 to 7, where the at least one processor is configured to: indicate to the plurality of TRPs to transmit the one or more RRSs on the set of common RRS tones for each of the multiple transmission occasions.

Aspect 9 is the apparatus of any of aspects 1 to 8, where the indication to mute the first sub-band or the second sub-band of the frequency band for the multiple transmission occasions includes a 2D bitmap, where one dimension of the 2D bitmap is associated with a frequency domain and another dimension of the 2D bitmap is associated with a time domain.

Aspect 10 is the apparatus of any of aspects 1 to 9, where the configuration further configures the plurality of TRPs to transmit each of the one or more RRSs with a same transmission power.

Aspect 11 is the apparatus of any of aspects 1 to 10, where the plurality of TRPs are associated with the base station or are part of the base station.

Aspect 12 is the apparatus of any of aspects 1 to 11, where the multiple transmission occasions correspond to one radar measurement instance.

Aspect 13 is a method of wireless communication for implementing any of aspects 1 to 12.

Aspect 14 is an apparatus for wireless communication including means for implementing any of aspects 1 to 12.

Aspect 15 is a computer-readable medium storing computer executable code, where the code when executed by a processor causes the processor to implement any of aspects 1 to 12.

Aspect 16 is an apparatus for wireless communication including a memory; at least one transceiver; and at least one processor communicatively connected to the memory and the at least one transceiver, the at least one processor configured to: transmit, to a plurality of TRPs, a TRP configuration to configure the plurality of TRPs to transmit one or more RRSs over multiple transmission occasions based on a frequency band; and transmit, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions.

Aspect 17 is the apparatus of aspect 16, where each of the multiple transmission occasions corresponds to one slot or one symbol.

Aspect 18 is the apparatus of any of aspects 16 and 17, where the indication further indicates the plurality of TRPs to switch between transmitting the one or more RRSs using the first sub-band and transmitting the one or more RRSs using the second sub-band across the multiple transmission occasions, such that the plurality of TRPs do not transmit the one or more RRSs using a same sub-band for two adjacent transmission occasions.

Aspect 19 is the apparatus of any of aspects 16 to 18, where the first sub-band overlaps with at least a portion of the second sub-band, where the at least a portion of the second sub-band corresponds to a set of common RRS tones.

Aspect 20 is the apparatus of any of aspects 16 to 19, where the at least one processor is configured to: indicate to the plurality of TRPs to transmit the one or more RRSs on the set of common RRS tones for each of the multiple transmission occasions.

Aspect 21 is the apparatus of any of aspects 16 to 20, where the at least one processor is configured to: transmit, to the plurality of TRPs, one or more frequency hopping sequences for the plurality of TRPs to apply the frequency hopping.

Aspect 22 is the apparatus of any of aspects 16 to 21, where the configuration further configures the plurality of TRPs to transmit each of the one or more RRSs with a same transmission power.

Aspect 23 is the apparatus of any of aspects 16 to 22, where the plurality of TRPs are associated with the base station or are part of the base station.

Aspect 24 is a method of wireless communication for implementing any of aspects 16 to 23.

Aspect 25 is an apparatus for wireless communication including means for implementing any of aspects 16 to 23.

Aspect 26 is a computer-readable medium storing computer executable code, where the code when executed by a processor causes the processor to implement any of aspects 16 to 23.

What is claimed is:

1. An apparatus for wireless communication at a base station, comprising:
a memory;
at least one transceiver; and
at least one processor communicatively connected to the memory and the at least one transceiver, the at least one processor configured to:
transmit, to a plurality of transmission reception points (TRPs), a TRP configuration to configure the plurality of TRPs to transmit one or more radar reference signals (RRSs) over multiple transmission occasions based on a frequency band; and
transmit, to the plurality of TRPs, an indication to mute at least one of a first sub-band or a second sub-band of the frequency band for transmitting the one or more RRSs in each of the multiple transmission occasions.

2. The apparatus of claim 1, wherein to mute the first sub-band or the second sub-band of the frequency band for transmitting the one or more RRSs, the plurality of TRPs are configured to transmit the one or more RRSs in the first sub-band or the second sub-band of the frequency band with zero-power.

3. The apparatus of claim 1, wherein each of the multiple transmission occasions corresponds to one slot or one symbol.

4. The apparatus of claim 1, wherein the indication further indicates the plurality of TRPs to switch between muting the first sub-band and muting the second sub-band across the multiple transmission occasions, such that the plurality of TRPs do not mute a same sub-band for two adjacent transmission occasions.

5. The apparatus of claim 1, wherein the plurality of TRPs transmit the one or more RRSs using a third sub-band of the frequency band in a first transmission occasion if the plurality of TRPs mute the first sub-band in the first transmission occasion, and the plurality of TRPs transmits the one or more RRSs using a fourth sub-band of the frequency band in a second transmission occasion if the plurality of TRPs mute the second sub-band in the second transmission occasion.

6. The apparatus of claim 5, wherein the third sub-band and the fourth sub-band do not overlap with each other.

7. The apparatus of claim 5, wherein the third sub-band overlaps with at least a portion of the fourth sub-band, wherein the at least the portion of the fourth sub-band corresponds to a set of common RRS tones.

8. The apparatus of claim 7, wherein the at least one processor is configured to:
indicate to the plurality of TRPs to transmit the one or more RRSs on the set of common RRS tones for each of the multiple transmission occasions.

9. The apparatus of claim 1, wherein the indication to mute the first sub-band or the second sub-band of the frequency band for the multiple transmission occasions includes a two-dimensional (2D) bitmap, wherein one dimension of the 2D bitmap is associated with a frequency domain and another dimension of the 2D bitmap is associated with a time domain.

10. The apparatus of claim 1, wherein the TRP configuration further configures the plurality of TRPs to transmit each of the one or more RRSs with a same transmission power.

11. The apparatus of claim 1, wherein the plurality of TRPs are associated with the base station or are part of the base station.

12. The apparatus of claim 1, wherein the multiple transmission occasions correspond to one radar measurement instance.

13. A method of wireless communication at a base station, comprising:
transmitting, to a plurality of transmission reception points (TRPs), a TRP configuration to configure the plurality of TRPs to transmit one or more radar reference signals (RRSs) over multiple transmission occasions based on a frequency band; and
transmitting, to the plurality of TRPs, an indication to mute at least one of a first sub-band or a second sub-band of the frequency band for transmitting the one or more RRSs in each of the multiple transmission occasions.

14. The method of claim 13, wherein to mute the first sub-band or the second sub-band of the frequency band for transmitting the one or more RRSs, the plurality of TRPs are configured to transmit the one or more RRSs in the first sub-band or the second sub-band of the frequency band with zero-power.

15. The method of claim 13, wherein the indication further indicates the plurality of TRPs to switch between muting the first sub-band and muting the second sub-band across the multiple transmission occasions, such that the plurality of TRPs do not mute a same sub-band for two adjacent transmission occasions.

16. The method of claim 13, wherein the indication to mute the first sub-band or the second sub-band of the frequency band for the multiple transmission occasions includes a two-dimensional (2D) bitmap, wherein one dimension of the 2D bitmap is associated with a frequency domain and another dimension of the 2D bitmap is associated with a time domain.

17. The method of claim 13, wherein the TRP configuration further configures the plurality of TRPs to transmit each of the one or more RRSs with a same transmission power.

18. An apparatus for wireless communication at a base station, comprising:
a memory;
at least one transceiver; and
at least one processor communicatively connected to the memory and the at least one transceiver, the at least one processor configured to:
transmit, to a plurality of transmission reception points (TRPs), a TRP configuration to configure the plurality of TRPs to transmit one or more radar reference signals (RRSs) over multiple transmission occasions based on a frequency band; and
transmit, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions.

19. The apparatus of claim 18, wherein each of the multiple transmission occasions corresponds to one slot or one symbol.

20. The apparatus of claim 18, wherein the indication further indicates the plurality of TRPs to switch between transmitting the one or more RRSs using the first sub-band and transmitting the one or more RRSs using the second sub-band across the multiple transmission occasions, such that the plurality of TRPs do not transmit the one or more RRSs using a same sub-band for two adjacent transmission occasions.

21. The apparatus of claim 18, wherein the first sub-band overlaps with at least a portion of the second sub-band, wherein the at least the portion of the second sub-band corresponds to a set of common RRS tones.

22. The apparatus of claim 21, wherein the at least one processor is configured to:
indicate to the plurality of TRPs to transmit the one or more RRSs on the set of common RRS tones for each of the multiple transmission occasions.

23. The apparatus of claim 18, wherein the at least one processor is configured to:
transmit, to the plurality of TRPs, one or more frequency hopping sequences for the plurality of TRPs to apply the frequency hopping.

24. The apparatus of claim 18, wherein the TRP configuration further configures the plurality of TRPs to transmit each of the one or more RRSs with a same transmission power.

25. The apparatus of claim 18, wherein the plurality of TRPs are associated with the base station or are part of the base station.

26. A method of wireless communication at a base station, comprising:
transmitting, to a plurality of transmission reception points (TRPs), a TRP configuration to configure the plurality of TRPs to transmit one or more radar reference signals (RRSs) over multiple transmission occasions based on a frequency band; and
transmitting, to the plurality of TRPs, an indication to transmit the one or more RRSs based on frequency hopping, such that the one or more RRSs are transmitted by the plurality of TRPs via at least one of a first sub-band or a second sub-band of the frequency band in each of the multiple transmission occasions.

27. The method of claim 26, wherein the indication further indicates the plurality of TRPs to switch between transmitting the one or more RRSs using the first sub-band and transmitting the one or more RRSs using the second sub-band across the multiple transmission occasions, such that the plurality of TRPs do not transmit the one or more RRSs using a same sub-band for two adjacent transmission occasions.

28. The method of claim 26, wherein the first sub-band overlaps with at least a portion of the second sub-band, wherein the at least the portion of the second sub-band corresponds to a set of common RRS tones.

29. The method of claim 28, further comprising:
indicating to the plurality of TRPs to transmit the one or more RRSs on the set of common RRS tones for each of the multiple transmission occasions.

30. The method of claim 26, further comprising:
transmitting, to the plurality of TRPs, one or more frequency hopping sequences for the plurality of TRPs to apply the frequency hopping.
